(19) United States
(12) Patent Application Publication
(10) Pub. No.: US 2012/0077890 A1
(43) Pub. Date: Mar. 29, 2012

(54) Composite Building Materials and Methods of Manufacture

(76) Inventors: Douglas Mancosh, Warwick, RI (US); David E. Murdock, Dublin, OH (US); James P. Przybylinski, St. Helena, CA (US)

(21) Appl. No.: 13/204,263

(22) Filed: Aug. 5, 2011

Related U.S. Application Data
(60) Provisional application No. 61/371,333, filed on Aug. 6, 2010.
(60) Provisional application No. 61/501,937, filed on Jun. 28, 2011.

(51) Int. Cl. C08K 3/26; C08K 3/22; C08L 77/06; C08L 97/02; C08L 67/00; C08J 9/35; C08K 7/02; C08L 23/12

(52) U.S. Cl. 521/68; 524/12; 524/430; 524/425; 524/427; 524/13; 524/14

(57) ABSTRACT

A composite building material includes carpet waste having carpet fibers and adhesive, and an inorganic filler that includes fly ash. The composite building material may be produced by providing the carpet waste, mixing the carpet waste with the inorganic filler to produce a homogeneous blend, and forming the homogeneous blend into the composite building material. The composite building material may optionally include a base polymer, slack wax, and/or calcium carbonate.

### CROSS-REFERENCE TO RELATED APPLICATIONS

This application claims priority to and the benefit of U.S. Provisional Patent Application Ser. No. 61/371,333, filed on Aug. 6, 2010, and U.S. Provisional Patent Application Ser. No. 61/501,937, filed on Jun. 28, 2011, the disclosures of which are hereby incorporated by reference in their entireties.

### FIELD OF THE INVENTION

This invention relates to systems and methods for fabricating plastic composites (PCs) and, more particularly, to systems and methods for plastic composites that employ recycled carpet waste as a component of the composite.

### BACKGROUND OF THE INVENTION

Natural and manmade composites can be used in building construction, industrial applications, consumer goods, automotive products, and other industries requiring moisture or thermal resistance with various physical properties, such as low moisture absorbance and low thermal distortion. The ability to build composites of this nature, while controlling physical properties such as strength, stiffness, ductility, impact resistance, and hardness, opens a variety of application opportunities. PCs, however, may be expensive to produce, due in part to the high cost of virgin thermoplastic materials used therein. While use of PCs may be desirable as an alternative to natural wood products to limit the depletion of timber resources, the high cost of PCs compared to wood products may limit their use. Moreover, manufacturing PCs requires the manufacturing of even more virgin plastics, thus presenting an additional environmental problem.

There exists growing pressure to re-utilize waste streams which are high in volume and low in degradability. In particular the manufacture, installation, use and (eventually) replacement of floor covering products, especially carpeting, produces a large amount of waste product. Carpet waste from new carpet production, post-consumer landfill or other used carpet applications, is a several billion pound-per-year waste problem. Often, carpet waste is not recycled, but rather is disposed of by land-filling or burning, with the obvious attendant environmental and cost concerns. An additional waste product that is produced in large quantities and must be either disposed of or otherwise contained to avoid pollution and associated health problems is fly ash, a coal combustion product.

What is needed, then, is a plastic composite that may still function acceptably in a variety of applications, while being inexpensive to manufacture, due to incorporation of readily available waste products.

### SUMMARY

Plastic composite building materials made with recycled carpet waste and fly ash exhibit good mechanical properties and improved resistance to moisture degradation and mildew. By incorporating waste products, such as carpet waste, fly ash, and slack wax, into the plastic composite building materials, the composites are less expensive to make, and pollution and health risks associated with the disposal or containment of the waste products is reduced.

In one aspect, a composite building material includes a homogeneous mixture of carpet waste including carpet fibers and adhesive, and an inorganic filler including fly ash. In certain embodiments, the composite building material includes, by weight of the composite, between about 1% and about 98% carpet waste, between about 10% and about 80% carpet waste, or between about 40% and about 80% carpet waste.

In one embodiment, the composite building material includes, by weight of the composite, between about 1% and about 80% fly ash, between about 15% and about 60% fly ash, between about 20% and about 30% fly ash, between about 10% and about 50% fly ash, or between about 35% and about 50% fly ash. In another embodiment, the inorganic filler further includes calcium carbonate. In yet another embodiment, the composite building material further includes calcium carbonate, beyond an amount present within the carpet waste. For example, the composite building material may further include, by weight of the composite, between about 1% and about 80% calcium carbonate, between about 15% and about 60% calcium carbonate, or between about 20% and about 30% calcium carbonate.

In one embodiment, the composite building material further includes a hydrophobic agent, which may include slack wax. In certain embodiments, the composite building material includes, by weight of the composite, between about 0.5% and about 10% slack wax, or between about 1% and about 3% slack wax. In another embodiment, the composite building material further includes a binding agent in intimate association with the carpet waste and the fly ash. The composite building material may include a lubricant. In still another embodiment, the carpet waste includes polypropylene, nylon 6, and/or nylon 6,6. The carpet waste may include face fibers having polyester.

In one embodiment, the composite building material further includes natural fibers, such as wood chips, wood flour, wood flakes, wood shavings, sawdust, flax, jute, abaca, hemp, rice hulls, and/or kenaf. In another embodiment, the composite building material includes a foaming agent. The composite building material may also include an additive, such as a colorant, a flame retardant, a compatiblizer, a coupling agent, and/or a mold inhibitor. In yet another embodiment, the composite building material further includes a base polymer. The composite building material may be characterized by an absence of natural fibers.

In one embodiment, the carpet waste includes a minimally processed carpet waste, an unseparated processed carpet waste, and/or a de-calcified carpet waste. The carpet waste may be pelletized carpet waste and/or powdered carpet waste. The composite building material may be siding, a shingle, a deck board, a trim board, a tile backerboard, floor underlayment, or a soffit.

In another aspect, a method of manufacturing a composite building material is provided. The method includes the steps of: providing carpet waste including carpet fibers and adhesive, mixing the carpet waste with an inorganic filler including fly ash to produce a homogeneous blend, and forming the homogeneous blend into the composite building material. In certain embodiments, the carpet waste includes pelletized carpet waste and/or powdered carpet waste. The inorganic filler may further include calcium carbonate.

In one embodiment, the mixing step further includes adding a hydrophobic agent, which may include slack wax. In another embodiment, the mixing step further includes adding a binding agent, which may include methylenediphenyldiisocyanate (MDI), urea formaldehyde (UF), melamine urea formaldehyde (MUF), and/or phenol formaldehyde (PF). The composite building material may include between about 10% and about 98% carpet waste and between about 2% and about 20% binding agent, by weight of the composite.

In one embodiment, the forming step occurs in a continuous press and/or a cycle press. The mixing step may occur in an extruder. The forming step may include passing the homogeneous mixture through an extrusion die. In another embodiment, the composite building material is siding, a shingle, a deck board, a trim board, tile backerboard, floor underlayment, and/or a soffit. A composite building material may be manufactured according to this process.

### DESCRIPTION OF DRAWINGS

Other features and advantages of the present invention, as well as the invention itself, will be more fully understood from the following description of the various embodiments, when read together with the accompanying drawings, in which:

FIG. 1 is a flowchart depicting the types of size reduction equipment and the variety of size reduction procedures depending on the final carpet waste material form desired for the process equipment, in accordance with an embodiment of the invention;

FIG. 2 is a schematic view of a system for recycling carpet for use in a plastic composite, in accordance with one embodiment of the invention;

FIG. 3 is a schematic view of a system for recycling carpet for use in a plastic composite, in accordance with another embodiment of the invention;

FIG. 4 is a schematic view of a system for recycling carpet for use in a plastic composite, in accordance with yet another embodiment of the invention;

FIG. 5 is a schematic perspective view of a plastic composite fabricated in accordance with one embodiment of the present invention;

FIG. 6 is a flowchart depicting steps for coating the processed carpet waste material with a binding agent and subsequent forming process to produce the plastic composite product, in accordance with an embodiment of the invention;

FIG. 7 is a flowchart depicting steps for finishing the plastic composite product, in accordance with an embodiment of the invention.

FIG. 8 is a schematic perspective view of a plastic composite extrusion fabricated in accordance with one embodiment of the present invention;

FIG. 9 is a schematic perspective view of a system for forming a plastic composite extrusion, in accordance with one embodiment of the present invention;

FIG. 10 is a cross-sectional schematic representation of a system for forming a plastic composite extrusion, in accordance with another embodiment of the present invention;

FIG. 11 is a schematic end view of a co-rotating twin screw extruder used in a system for forming a plastic composite extrusion, in accordance with another embodiment of the present invention;

FIG. 12 is a schematic perspective view of a Y-block adapter and extrusion die assembly used in a system for forming a plastic composite extrusion, in accordance with another embodiment of the present invention;

FIG. 13 is a schematic perspective view of a system for forming a plastic composite extrusion, in accordance with another embodiment of the present invention; and

FIG. 14 is a schematic end view of a co-rotating twin screw extruder used in a system for forming a plastic composite extrusion, in accordance with another embodiment of the present invention.

### DETAILED DESCRIPTION

The systems and methods described herein may be used to produce composite building materials from recycled carpet waste. The resulting composites may have properties that are equivalent to those for similar composites made with virgin plastics, rather than recycled carpet waste. In one embodiment, the composites are produced by pressing and heating a mixture of carpet waste and a binding agent. In another embodiment, the composites are produced by mixing, heating, and extruding the carpet waste. These embodiments are discussed in more detail below.

Unless otherwise noted, the use of one material when describing a particular application, process, or embodiment does not limit the described application, process, or embodiment to the specific material identified. The materials may be used interchangeably, in accordance with the described teachings herein. Moreover, the terms “plastic composites,” “PCs,” “wood plastic composites,” “WPCs,” “composite sheets,” “carpet waste composites,” and the like, are used interchangeably herein to describe plastic composite boards or sheets made from carpet waste which may include additional additives, such as fly ash. In addition to PCs, other composite products may be manufactured utilizing, in whole or in part, carpet waste. A non-limiting list of such composite products includes plastic piping, molded articles such as flower pots or seeding trays, building siding or roofing, shingles, molding, trim boards, soffits, fencing, furniture, or other types of extruded, injection molded, and/or compression molded products.

### Preparation of the Carpet Waste

In certain embodiments, the carpet waste used to form the composites described herein is made up of selvedge, post-industrial carpet waste, post-consumer carpet waste, and/or waste carpet reclaimed from landfills. Post-industrial carpet waste refers generally to waste material produced as a byproduct to the manufacturing process, such as trimmed carpet segments, as well as to carpet that fails to pass quality or other inspections, thus rendering it unsuitable for consumer use. Post-consumer carpet waste refers generally to carpet waste that is generated during installation at a consumer site or that is removed from a consumer site during demolition and/or replacement. Regardless, the terms selvedge, carpet waste, waste carpet, reclaimed waste, recycled waste, and similar terms are used herein interchangeably and may be used in the processes described herein interchangeably. These materials generally will be in baled form to begin the size reduction phase of the pre-processing. The bales vary in size but usually are about 1000 lb. to about 2000 lb. All of the equipment described in the carpet reduction processes below may be supplied by Pallmann Maschinenfabrik GMBH, or other manufacturers that produce similar equipment. Alternative manufacturers of specific equipment are identified below.

The references herein to unseparated processed carpet waste, recycled carpet waste, or variants thereof, refer to materials arrived at after processing either or both of industrial carpet waste and post-consumer carpet waste. Industrial carpet waste results from the carpet manufacturing process and is in large part the “edge-trim” material, referred to as selvedge. Post-consumer carpet waste is material resulting from replacement of used or damaged carpet. This post-consumer material is normally an amalgamation of carpet with different face fibers. As an example, the post-consumer carpet waste may be wool, nylon, polyester, polypropylene, or blends of all the previous fibers. The recycling process may include the classification of the waste carpet by type of face fiber if desired. In general, any type of carpet, new or used, soiled or clean, may be recycled and utilized in this invention.

A common type of carpet in both residential and commercial applications includes, namely, fabric pile, backing (which may be comprised of one or more discrete backing layers), and adhesive. The fabric pile is comprised of a number of twisted threads of natural and/or synthetic fabric or yarn. These twisted threads of fabric or yarn are herein described as having two portions: “face fibers” and “bound fibers.” “Face fiber” describes the portion of the fabric pile that extends up from the backing, and is of various manufactured styles, including tufted, looped, etc. “Bound fiber” describes the portion of fabric pile that is woven into and bound to the underlying backing of, e.g., polypropylene. The bound fabric is generally looped into at least one layer of backing and secured thereto with a latex or other chemical adhesive. A secondary layer of backing may also be present to provide additional structure to carpet.

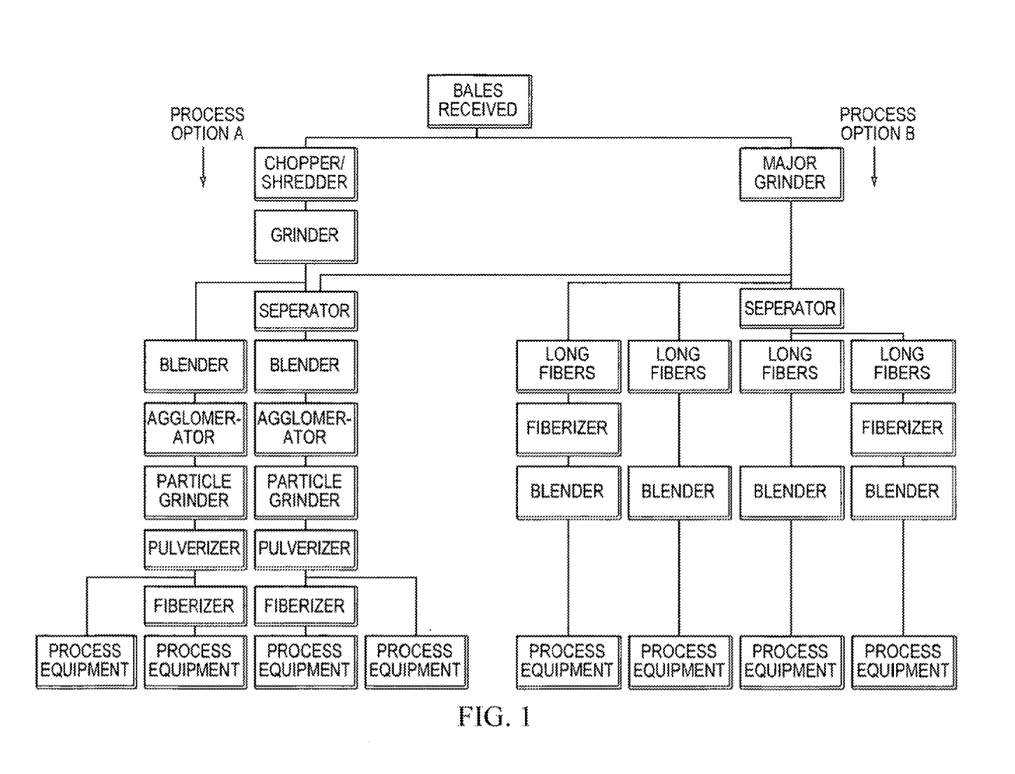

FIG. 1 shows the types of equipment and the variety of procedures for carpet waste size reduction, depending on the final form desired for the process equipment, in accordance with an embodiment of the invention. The final form may also be dependent on the desired finished composite product and physical or visual appearance properties. In short, the carpet waste may be processed as described below to reduce its size. In one embodiment, the size-reduced carpet waste is then mixed or coated with a binder to produce material that is subjected to heat and/or pressure to yield composite material. The size reduction process may take place at the same facility where the PCs are manufactured, or the carpet waste may be processed at a first facility and delivered to a second facility for incorporation into the PC products. Post-manufacture treatments for the composite material are also described below.

The first step in the size reduction phase includes reducing the waste to a manageable size for the remainder of the process. In the embodiment depicted in FIG. 1, either a combination of a shredder/chopper and grinder (Process Option A), or a major capacity grinder (Process Option B) is used to process the materials to smaller sizes. Process Option A may be used to reduce carpet waste to pellets or granules that may be further processed into various PC products. The shredder/chopper first reduces the selvedge or carpet waste to chunks approximately three inches square (3″×3″), although other sizes are contemplated, depending on the equipment used. In addition to Pallmann Maschinenfabrik, the shredder/chopper may be manufactured by Vecoplan, LLC, or Weima America, Inc. The shredded material then passes through a grinder which further reduces the chunks to a fiber fluff material with a diameter of the fibers similar to the diameter of the original carpet fibers and a length of about 0.25″ to about 1″. Other manufacturers of comparable grinders include Vecoplan, LLC, Cumberland Engineering Corp., and Republic Machine, Inc.

The waste optionally can be run through a separator which acts as a hammer mill/cyclone to remove the dirt from the carpet waste. In this step, some of the carpet backing containing inorganic fillers may also be removed. Generally, however, it is unnecessary to deliberately separate the various carpet components prior to incorporating the recycled carpet waste into PCs. All of the components of carpet may be used, not only one component, such as the carpet fibers, as certain known methods disclose. Thus, manufacturing time is decreased, since the step of component separation is not utilized. The slightly-size reduced material, due to the hammer mill effect, is ready for the next step, the agglomeration process, while the dirt and carpet backing materials that may have been removed from the small chunks are disposed. Carpet backing that is not removed, however, may not have any adverse effect when incorporated into a PC using recycled carpet waste. The fiber fluff, regardless of the use of the separator or not, also may be blended with other materials such as wood or natural fibers, synthetic fibers (i.e., fiberglass), inorganic fillers, or other reinforcing fillers. The fiber fluff material or the blended material is then conveyed to the agglomeration step.

The agglomeration of the above materials occurs inside the agglomerator. The materials enter a horizontal drum containing a revolving rotor that is shaped so as to force the fiber fluff or blends against the drum wall. The drum wall is perforated so that, as the rotor forces the contained materials against the perforated wall, the material is forced through the perforations, thereby forming strands of generally uniform diameters. On the outside of the drum are stationary knives which cut the strands into generally uniform lengths. During this process, the material is heated by friction to a temperature greater than a melting point of at least a portion of the carpet waste fibers. For example, the material may be heated to a temperature that remains below the melting point of the highest melting point material in the blend. In other embodiments, the material is heated to a temperature that is greater than the melting points of the carpet waste fibers, such that all of the carpet waste fibers are melted. The temperature is controlled by the speed of the rotor, the diameter of the perforations, and the thickness of the drum wall. As each component of the carpet waste, i.e., backing and carpet fibers, is pressed against the wall of the drum, that material heats up due to friction, until the material sufficiently softens, such that it is then pressed through the perforated drum by the rotor. The agglomerating machinery could be replaced by a pellet mill manufactured by Bliss Industries or California Pellet Mill Co.

The pellets or granules that are formed in the agglomeration step are generally cylindrical in shape and approximately 0.125″ in diameter and about 0.125″ to about 0.25″ long. The diameter and length of the granules can be modified by changing the diameter of the holes in the drum wall and/or changing the speed of the rotation against the knives. Because the granules are hot when they are formed and cut to length, some of the granules may be stuck to one another. Therefore, for better size consistency, the granules next pass through a granulator or grinder which separates any stuck granules. This granulator step may also be used to reduce the size of the granules, and/or the granules may be further reduced in size by a pulverizer (not shown). For example, if the final desired dimension is less than 0.125″, the pulverizer may be used to reduce the particle size to 8-16 mesh. This is the equivalent of about 0.04″ to about 0.10″. Other sizes, up to and greater than about 20 mesh are also contemplated. For example, the particle sizes may be up to about 100 mesh. These pellets or granules may be bagged, stored in a silo, or fed directly to the extrusion system, as desired. Alternatively or additionally, the carpet waste may be processed into a powder or other desired form. Particles that are sized to pass through a 3 mm-4 mm mesh screen may be utilized.

As an optional step, the granules or pulverized particles may be fiberized. The fiberizing process includes a mechanical roughing of the surface so that the surface takes on a fuzz-like characteristic that may be desirable for the composite product process described below. After processing to the desired condition, the material is then sent to the composite production process.

As an alternative to the above process, Process Option B may be used to reduce carpet waste to a fiberized mass. First, a major capacity grinder reduces the carpet waste to fibers about 0.25″ to about 1.0″ in length and about 1/32″ to about 0.125″ in diameter. These random-sized fibers are ready for the agglomeration process or for alternative processes not requiring agglomeration. Next, the material optionally may be passed through a separator, as described above. The fibers may then be passed through the agglomeration process as described above, or the fibers may pass directly to the fiberizer equipment. Again, the fiberizer changes the surface characteristics of the fibers, giving them a fuzz-like surface with greater surface area and a different bulk density. The fiberizing step is again optional, and may not be required for all end uses of the composite products. Next, the fibers pass through a blender where wood or natural fibers, synthetic fibers (e.g., fiberglass), inorganic fillers (e.g., fly ash and/or calcium carbonate), and/or mineral fillers (if any) may be added. Once the blending of the fibers and added materials is complete, the blend is ready for the composite production process.

Significantly, it has been determined that it is not necessary to separate or classify the various materials contained in selvedge or carpet waste, even though most carpet surface materials are nylons, polyester, polypropylene, or wool and the backing material is usually polypropylene and/or highly filled synthetic latex. These materials exhibit considerably different physical properties and processing properties, but the entire waste product may be used in the composite sheet material, regardless of the differences in the components that comprise the carpet waste. The waste carpet, having been made into an agglomerate, a fiberized agglomerate, a pulverized agglomerate, a fiberized, pulverized agglomerate, a fiberized fluff, etc., becomes the base material for the composite product. Additionally, other waste fiber or fiberized waste fiber may also be used to manufacture a composite product. The whole range of materials in carpet waste may be part of the composition.

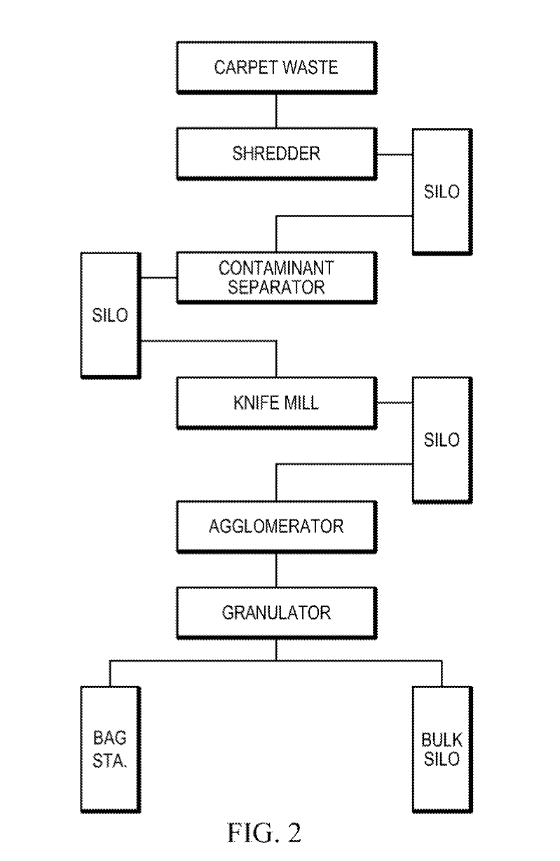

FIG. 2 depicts a schematic view of a system for recycling carpet to produce pelletized carpet waste, in accordance with an embodiment of the present invention. In one embodiment, post-industrial (selvedge) carpet or post-consumer carpet is first fed through a shredder, chopper, or other unit that mechanically cuts the carpet into pieces approximately three inches square (3″×3″), although other sizes are contemplated, such as about 2″×2″ to about 4″×4″, depending on the equipment used. The shredder may be manufactured by Pallmann Maschinenfabrik, Vecoplan, LLC, Weima America, Inc., or other suitable manufacturers. These smaller pieces are then fed to a vertical cyclone separator where dirt and other contaminants are removed from the carpet material. A knife mill then cuts or shreds the remaining pile fibers into untwisted loops about one-half inch to about 1 inch in length. These fibers then pass through another vertical cyclone to remove dirt and other remaining contaminants. In this step, some of the carpet backing containing inorganic fillers may also be removed. Generally, however, it is unnecessary to separate the various carpet components prior to incorporating the recycled carpet waste into PCs. All of the components of carpet may be used, not only one component, such as the carpet fibers. Thus, manufacturing time, cost, and the total amount of carpet waste required are decreased, since the step of component separation is not performed. The slightly-size reduced material, due to the knife mill processing, is ready for the next step, the agglomeration process, while the dirt and carpet backing materials that may have been removed from the small chunks are disposed. Carpet backing that is not removed, however, does not have any adverse effect when incorporated into a PC using recycled carpet waste according to the teachings herein. The shredded carpet waste material, or “fiber fluff,” also may be blended with other materials such as wood or natural fibers, synthetic fibers (e.g., fiberglass), inorganic fillers (e.g., fly ash or calcium carbonate), or other reinforcing fillers. The fiber fluff material or the blended material is then conveyed to the agglomeration step, described above.

Used herein, the material exiting the agglomerator is referred to interchangeably as “unseparated processed carpet waste,” “processed carpet waste,” “carpet waste,” “recycled carpet waste,” or variants thereof. “Unseparated” refers to the fact that the various components of the waste carpet need not be separated from each other prior to processing into composite materials. In one embodiment, the individual granules of material exiting the agglomerator are a combination of fiber (generally nylon, polyester, polypropylene, etc), with an outer layer or coating of other carpet materials (backing, adhesive, etc.) having lower melting points. Since this outer layer of other carpet materials is substantially melted during the agglomeration process, the individual coated fibers that exit the agglomerator tend to stick together. A granulator is used to separate these individual fibers pellets. Unseparated processed carpet waste tends to have a high level of mineral filler (latex adhesive may include calcium carbonate, for example). This mineral filler may comprise up to about 25% or more of the total weight of a carpet sample. In certain plastic composites utilizing unseparated processed carpet waste, this mineral filler may result in a relatively heavy finished article. However, in the composite building material described herein, the mineral filler comprises a relatively small percentage of the total amount of the finished product.

Unseparated processed carpet waste is particularly desirable for certain applications, as it eliminates the step of separating the various carpet components, thus reducing manufacturing time and costs. However, it has been discovered that separation of the various carpet components may provide certain advantages, as those separated components may be processed into a form more readily amenable to storage or transportation. Additionally, separated carpet may also have particular advantages over unseparated processed carpet waste in plastics processes that require more chemically consistent materials for proper processing.

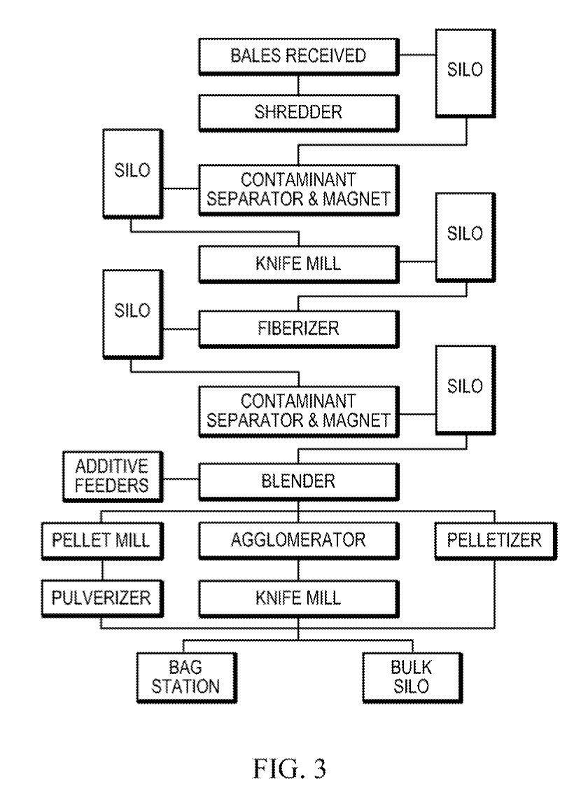

In that regard, FIG. 3 depicts a schematic view of an alternate system for recycling carpet to produce pelletized carpet waste that is free or substantially free of calcium carbonate, in accordance with an embodiment of the invention. This type of processed carpet waste is referred to herein as “de-calcified carpet waste,” since the latex adhesive that includes calcium carbonate has been partially or substantially entirely removed from the carpet waste. The de-calcified carpet waste may be used in the same formulations and processes described herein as those used for unseparated processed carpet waste. Although some adhesives used in the manufacture of carpet do not include calcium carbonate, calcium carbonate is contained within latex adhesive and may comprise up to about 25% or more of the total weight of a waste carpet. If unremoved from waste carpet, it may add undesirable weight to products made with recycled carpet waste; accordingly, separation from the backing from the carpet fibers may be desirable in certain applications. In addition to calcium carbonate, other inorganic filler may be present in carpet adhesive, e.g., talc. The processes described herein may be used to remove any inorganic filler from carpet adhesive, including calcium carbonate, talc, or other types of fillers. In the depicted system, post-industrial (selvedge) carpet or post-consumer carpet is first fed through a shredder, chopper, or other unit that mechanically cuts the carpet into pieces approximately three inches square (3″×3″), although other sizes are contemplated, such as about 2″×2″ to about 4″×4″, depending on the equipment used. The shredder may be manufactured by Pallmann Maschinenfabrik, Vecoplan, LLC, Weima America, Inc., or other suitable manufacturers. These smaller pieces are then fed to a dirt or contaminant separator.

The separator can be a vertical cyclone separator manufactured by Pallmann Maschinenfabrik, or a vibrating screener, or a Liwell-type agitating screener manufactured by Hein, Lehmann Trenn- and Fordertechnik GmbH. The separator removes dirt and other contaminants from the carpet material, which is then passed to a knife mill that cuts or shreds the remaining pile fibers into mostly untwisted loops about one-half inch to about one inch in length. These fibers then pass through a fiberizer, which may be a double-stream mill that is airswept for gentle pulverizing of the carpet material. One such fiberizer that is manufactured by, for example, Pallmann Maschinenfabrik ensures cool grinding at a high throughput capacity with a narrow particle size distribution. In general, the fiberizer unravels any remaining twisted fiber loops and removes any remaining adhesive from the fibers and backing A second dirt or contaminant separator having a smaller mesh screen than the first separator is then used to remove additional contaminants. In this step, a substantial amount of the adhesive containing inorganic fillers (e.g., calcium carbonate) may be removed. Removal of a substantial amount of the calcium carbonate may reduce the weight of finished products that utilize recycled carpet waste in their manufacture.

In one processing option, after passing through the second separator, the fibers may be further processed with an agglomerator, as described with regard to FIGS. 1 and 2. After the agglomeration process, the material may pass through another knife mill to further size reduce the material. This last size reduction may be necessary to make the material easier to feed into extrusion, injection or other types of plastics processing machinery. In an alternative process, the agglomerating machinery could also be replaced by a pellet mill manufactured by Bliss Industries or California Pellet Mill Co.; a pulverizer also may be utilized to reduce the processed waste to a powder. In still another alternative process, a pelletizing extruder or other densifying machinery may be used. The extruder can be a single screw or a twin screw (counter or co-rotating). Manufacturers of single screw extruders specifically designed to process recycled polymer fibers include Erema North America, Inc. The pelletized material is then moved to a bag station or a bulk storage silo, and may be utilized in other plastics processing.

As noted above, in certain carpets, the calcium carbonate contained in the backing material may comprise as much as about 25% or more of the total weight of the recycled carpet waste. By utilizing the system described in FIG. 3, removal of calcium carbonate may be controlled, resulting in reduction of all or a significant amount of the calcium carbonate. Total amounts of calcium carbonate (based on the original weight of the carpet waste) of about 0% to about 20% may be obtained and desirable. Preferably, amounts of about 1% to about 10% may also be obtained; more preferably, amounts of about 2% to about 5% may be obtained. The removed calcium carbonate may be used as a filler in other materials and products.

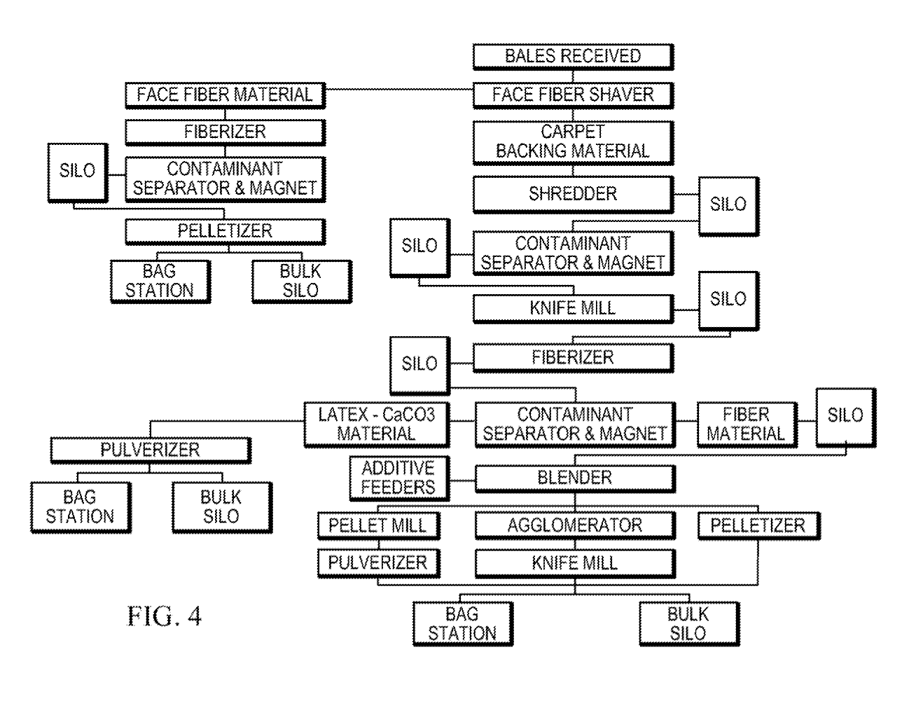

FIG. 4 depicts a schematic view of a system for recycling carpet to separate and produce three usable material streams, in accordance with an embodiment of the invention. In this system, the face fiber is shaved from the backing, fiberized, contaminant separated, and pelletized. The remaining carpet backing material contains a reduced percentage of fiber pile (i.e., the bound fiber) and all of the backing material, which may comprise the one or more backing layers and adhesive, which may contain calcium carbonate. A certain amount of the latex adhesive containing calcium carbonate can be separated from the bound fibers and backing layer(s), size reduced, and used as a filler for other materials. The remaining bound fibers and polypropylene backing fibers can be densified and used in the same formulations and processes as described for the unseparated processed carpet waste described herein. These remaining bound fibers and backing fibers are referred to herein as “minimally processed carpet waste,” which is comprised essentially of de-calcified carpet waste, which has previously had some amount of the face fibers removed therefrom. During processing, the bound fibers may become unbound from the backing fiber. For clarity, these fibers are still referred to “bound fibers,” even though they may no longer be physically bound to the backing.

In the depicted embodiment, post-industrial or post-consumer carpet is first identified by face fiber and sorted. It is then fed into a shaving machine that utilizes a rotary, self-sharpening band saw to shave the face fibers from the carpet backing Exemplary shaving machines are manufactured by Rizzi 1857 S.p.A., Flamar Italia Srl, Poletto Technology, and others. Shaving the face fibers may inadvertently remove some amount of backing material from the waste carpet as well. In order to remove this backing material, the face fibers are then fed into a fiberizer, followed by a separator, both of which are described above with regard to FIG. 3. Thereafter, the face fiber may be fed into a pelletizing extruder or other densifying machinery, as described above with regard to FIG. 3.

The remaining carpet backing material that contains a reduced percentage of fiber pile (i.e., the bound fiber) and all of the backing material is now fed into a shredder/chopper, a first separator, a knife mill, a fiberizer, and a second separator as described above with regard to FIG. 3. As the carpet waste passes through the second separator, some or most of the latex adhesive (containing calcium carbonate) may be removed. The calcium carbonate may then be passed to a pulverizer, as described above. The remaining material, which is comprised of backing material (i.e., bound fibers, polypropylene backing fibers, and a reduced amount of adhesive) may then pass to one of three subsequent processing sequences: (1) a pellet mill and pulverizer, (2) an agglomerator and knife mill, or (3) a pelletizer. These three processes are described above with regard to FIG. 3.

### Formation of Plastic Composites by Pressing and Heating

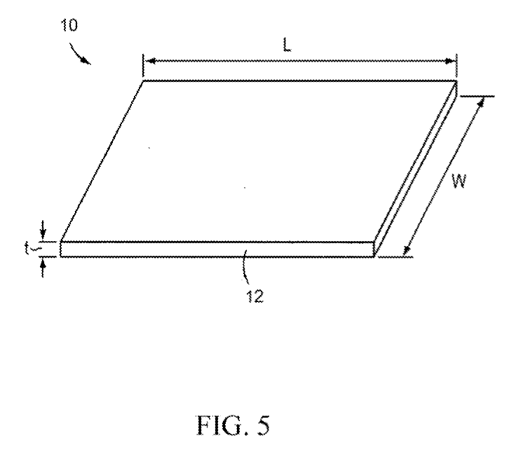

In certain embodiments, following the preparation of the carpet waste described above, a plastic composite is produced by mixing carpet waste with a binding agent and pressing and heating the mixture into a desired shape. FIG. 5 shows one embodiment of a sheet or board plastic composite 10 including recycled carpet waste formed in accordance with the present disclosure. The composite 10 is generally a dimensional composite body 12 formed from a mixture including recycled carpet waste and a binding agent. Length L, width W, and thickness t, of the composite 10 are dictated by the production machinery used. Functional performance parameters of the composite 10 may be defined in part by the amount of carpet waste, binding agent, natural and/or inorganic fillers (e.g., fly ash), and other optional additives. In general, however, the density of the composite 10 is directly related to the total amount of carpet waste and fillers used, the final thickness t of the board, and an amount of foaming of the composite 10, if present. The recycled carpet waste, which may be blended or dispersed with inorganic and/or natural fillers within the fiber-polymer compound, results in a composite having physical properties equivalent to PCs made with virgin thermoplastics. As described above, the recycled carpet waste may be processed into a fiber fluff, or other form, from post-industrial or post-consumer carpet waste. Depending on the composition of the carpet used, the recycled carpet waste can include wool, nylon, polyester, polypropylene, jute, sisal, like materials, and combinations thereof. Due at least in part to processing controls, described in greater detail in the following paragraphs, the recycled carpet waste is dispersed and distributed substantially uniformly throughout the composite 10.

Various binding agents may be utilized as desired for a given application. Certain embodiments of a PC made in accordance with the present invention utilize methylenediphenyldiisocyanate (MDI). MDI acts as a binding agent for the fibers or agglomerated carpet waste materials to contribute to the structural integrity of the composite products. As an alternative to MDI, binding can be accomplished using urea formaldehyde (UF), melamine urea formaldehyde (MLTF), phenol formaldehyde (PF), similar binding agents, and combinations of agents.

In addition to the binding agent, the composite 10 may incorporate natural fibers to help provide the composite with the appearance and feel of a natural wood product. Types of natural fibers, such as wood fillers or the like, include wood chips, wood flour, wood flakes, wood shavings, sawdust, flax, jute, abaca, hemp, kenaf, rice hulls, like materials, and combinations thereof. The sizes of the various natural fibers is not critical and may range from that of sawdust and wood flour, up to and exceeding 1″ long wood chips, though fibers and chips less than about 0.5″ may be preferred.

The composite may include additives such as colorants, lubricants, flame retardants, compatiblizers, coupling agents, other materials, and combinations thereof. The relative amounts of components (i.e., recycled carpet waste, filler, additives, etc.) may be modified as desired for a particular application. The various component amounts, ratios of components, and finished composite properties, in certain embodiments, are described in more detail below.

In certain embodiments, in addition to the carpet waste and the binding agent, the composite 10 includes an inorganic filler. The inorganic filler may be, for example, fly ash (a coal combustion product). As a percentage of total weight of the composite 10, the amount of fly ash in the composite 10 may be from about 1% to about 80%, from about 15% to about 60%, or from about 20% to about 30%. Advantageously, the fly ash may act as a flame retardant and/or a biocide or mildewcide.

In another embodiment, the inorganic filler additionally includes calcium carbonate. While calcium carbonate may be present in the carpet waste (e.g., as part of the adhesive holding the carpet materials together), the composite may include additional calcium carbonate, beyond an amount present in the carpet waste constituent. For example, in certain embodiments, as a percentage of total weight of the composite 10, the amount of calcium carbonate in the composite 10 is from about 1% to about 80%, from about 15% to about 60%, or from about 20% to about 30%. In one embodiment, the total amount of inorganic filler (e.g., fly ash plus calcium carbonate), as a percentage of total weight of the composite 10, is from about 1% to about 80%, from about 15% to about 60%, or from about 20% to about 30%.

In certain embodiments, the composite includes a hydrophobic agent, which may include slack wax. As a percentage of total weight of the composite 10, the amount of slack wax in the composite 10 may be from about 0.5% to about 10%, or from about 1% to about 3%. The slack wax may make the composite 10 more water repellent.

Use of fly ash in plastic composites has economic, environmental, and performance advantages. With regard to economics, fly ash is generally less expensive than natural fibers such as wood and wood flour. Environmentally, fly ash must be disposed of or otherwise contained to prevent dispersal, inhalation, or other contamination. Fly ash consists almost exclusively of metal oxides, and absorbs considerably less moisture than other natural fibers, such as wood. Therefore, when used in a plastic composite, degradation due to mold growth and water absorption are greatly reduced. If fly ash completely replaces natural fibers (e.g., in a wood-plastic composite), mold growth and water absorption may be substantially or completely eliminated. Additionally, compared to natural fibers such as wood, fly ash provides plastic composites with substantially the same or similar mechanical properties, such as stiffness.

The weight of the fly ash used in the formulations may require the use of density reduction methods (e.g., foaming) to reduce the weight of the finished product, depending on the desired final application for the product. Density reduction may include use of endothermic, exothermic, or endothermic/exothermic blend chemical foaming agents in the formulation, injection of gas such as nitrogen or carbon dioxide into the constituent materials, or other physical foaming agents. The resulting composite 10 may include an open cell foam and/or a closed cell foam.

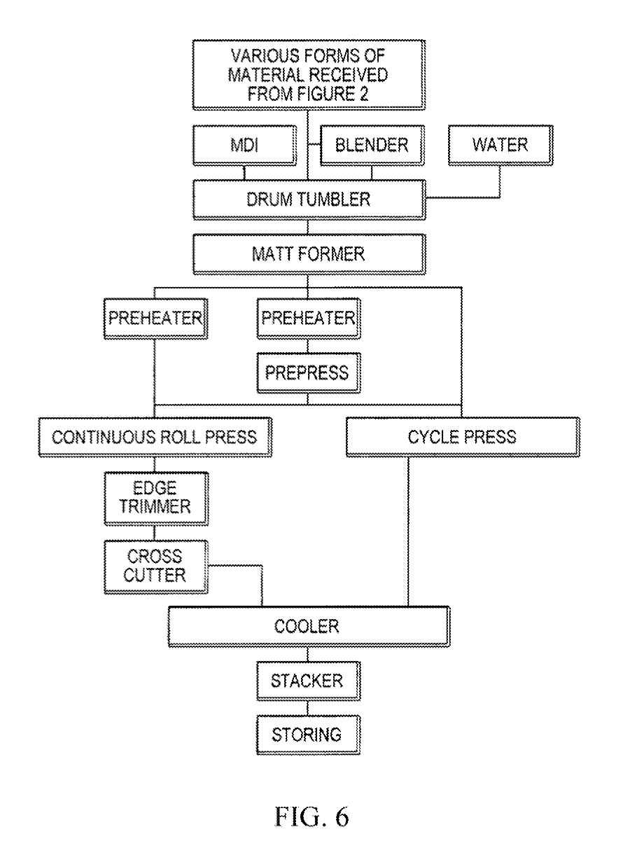

After the size reduction process(es), described above and shown in FIGS. 1-4, the carpet waste is ready to be formed into composite sheets, a process which is depicted in FIG. 6, in accordance with an embodiment of the invention. The carpet waste materials may be loaded into a large rotating drum or a drum with rotating mixing blades and/or a resination blow line. This equipment is used to coat the carpet waste with a binding agent. Other materials such as natural fiber fillers or inorganic fillers (e.g., fly ash, additional calcium carbonate, etc.) may be loaded with the carpet waste material, as well as water repellants (e.g., slack wax). If the material is loaded into a drum, water and/or a binding agent (such as MDI) are sprayed out of the resination blow line to coat the materials, while the drum and/or blades spin to cause the material within to become evenly distributed. The addition of water may achieve a desired moisture content for the material and prepare the material for the binding agent. For the resination blow line method, the material is blown through a tube that has water and MDI introduced into it. The blowing action causes the air to become turbulent which allows the water and MDI to evenly coat the material. In one embodiment, the binding agent is applied in this manner to the granules or fibers at a concentration of about 1% to about 20% of the total weight of the granules plus any other additives. Concentrations between about 2% to about 10% and about 5% to about 6% are also contemplated. Generally, higher concentrations of resin produce composite sheets with higher moduli of elasticity and rupture. This coated carpet waste dries rapidly under ambient conditions, allowing the granules or fibers to continue to flow without adhering to one another. Accordingly, once coated and dried, the resin coated particles need not be used immediately, and may be stored and/or transported for later use.

The MDI-coated carpet waste and other additives (if applicable) are conveyed to a mat forming station that includes conveyors, metering scales, spreader heads, and a control management system. The spreading equipment distributes the material onto a forming belt such that the spread material becomes a mat which has a generally uniform thickness, width and initial density. Alternative, the mat may have a non-uniform thickness to produce, for example, composite building materials such as shingles or trim boards, which may have a varying thickness. Board properties may be determined by the shape of the carpet waste composite particles/fibers and by their position in the formed mat. Additionally, the forming station can distribute more than one type of material for a multi-layered board. For example, the spreader head in the forming station could spread a mat of fibers on the forming belt, then a second spreader head could spread a mat of pellets on top of the fibers, then a third spread head could spread a top layer of fibers onto the pellets. Many different combinations of materials can be spread onto the forming belt to make various types of boards. The number of layers per board also can be varied. For example, a board could be manufactured to have an outer layer of carpet waste with a fiberglass core, or an outer layer comprising carpet waste pellets, and carpet waste fiber underlayers with a carpet waste pellet core.

After the mat is spread formed, the forming belt then transports the mat into a pre-heater, a pre-press, or directly to a press machine. The pre-heater and pre-press may be utilized to reduce total processing time of the composite sheet. Due to the thermal inertia and thickness of the material, heat from the press platens or rolls may take longer to penetrate the total thickness of the mat, thereby extending process time and costs. Preheating brings the temperature of the entire mat up to a higher starting temperature. The pre-press compresses the starting materials to a thickness that is more appropriate for introduction into the final presses and, additionally, the pre-heater and pre-press may be a single unit or separate units. In certain embodiments, the temperature of the mat can be elevated from about 65° F. to about 200° F. before entering the board forming process. This rapid heat transfer to the carpet waste may be accomplished by microwaves or by the injection of a steam/air mix (moist air) alternately from either surface into the mat. The steam condenses during this process, transferring the heat into the mat. The pre-heater may also pre-press or compress the material before it enters the board forming process. The heated mat is then transferred by an intermediate belt conveyor to the compression section of the infeed end of a continuous roll press or into a cycle press which is the beginning of the board-forming process.

In one embodiment, composite sheets are manufactured using a cycle press, which may have single or multi-daylight openings. Ranges of various process parameters for manufacturing various embodiments of PCs utilizing recycled carpet waste in a cycle press are presented in Table 1, below. The composite material is transferred into the cycle press where it is subjected to heat and pressure from a top and bottom platen that compresses the mat to a predetermined thickness or height. The elevated temperature and pressure activates the binding agent and, depending on the temperature, melts certain of the carpet components (e.g., carpet waste fibers having lower melting points) while leaving others (e.g., carpet waste fibers having higher melting points) unmelted, to produce a finished board or sheet. During the cycle press process, steam may be injected into the mat to ensure thorough heating of the binding agent and bonding of the composite material. The cycle press may also use an active cooling cycle to reduce the temperature of the board before it exits the press. The platens may be engraved with a pattern to give the board outer surface a structured pattern.

TABLE 1
Composite Sheet Processing Parameters (Cycle Press)

Range

| | High | Low |
|---|---|---|
| Total Time for heating material, during | 360 | 60 |
| press-cycle [sec] | | |
| Temperature of Heating Plates | 600 | 100 |
| [° F.] | | |
| Pressure of Heating Press [psi] | 6000 | 150 |
| Internal Temperature of Board [° F.] | 500 | 340 |
| Cure Time [sec] | 30 | 5 |
| Transition Time from Heating to Cooling | 600 | 0 |
| Press [sec] | | |
| Total Time for cooling material, during | 360 | 60 |
| press-cycle [sec] | | |
| Temperature of Cooling Plates | 300 | 32 |
| [° F.] | | |
| Pressure of Cooling Press [psi] | 6000 | 150 |
| Internal Temperature of Board [° F.] | 300 | 70 |

Heat is generally delivered to the platens by using hot water, steam, electric coils, or circulating heated chemicals. In certain embodiments of the process, the platens may be heated from about 100° F. to about 600° F. Temperature ranges from about 200° F. to about 550° F., and about 340° F. to about 420° F. also may be desirable. Additionally, temperature ranges from about 420° F. to about 550° F. may be utilized. Final internal temperatures of the composite being compressed within the cycle press will be dependent at least in part on the temperature of the platens and compression time. If left in the cycle press for a sufficient period of time, the internal temperatures of the composite material will generally equal those of the platens, the ranges of which are given above. Final internal temperatures up to about 250° F., about 300° F., about 340° F., about 350° F., about 400° F., about 420° F., and about 480° F. have produced composite sheets displaying acceptable performance. Unlike known recycled carpet waste composite sheet material manufacturing processes, which heat the composite sheets to a temperature below the melting points of the carpet fibers and other carpet components, it has been discovered that heating the carpet waste to higher temperatures may be desirable. For example, temperatures of approximately 340° F. will melt polypropylene, a component in many modern carpet constructions, without melting any nylon fibers (that melt at about 420° F.). The melted polypropylene, combined with binding agent resins of the types disclosed herein, form a sheet material having very desirable properties. The unmelted nylon provides additional structural strength to the finished composite and may increase flexural strength, though completely melting the carpet fibers can also produce a PC displaying acceptable performance properties. Pressures applied by the platens in the heating press may range from about 150 psi to about 6000 psi or greater, to obtain a the desired thickness and density.

The cycle press may include channels within the platens that thereafter circulate water or chemical coolant(s) to reduce the temperature of the board. The water or coolants may be chilled and volumetric flow rates controlled to reduce the total cooling time for the board to achieve acceptable manufacturing cycle time. This cooling step may take place in the heating press or the board may be transferred from the heating press to a cooling press. If the board is transferred from the heating press to the cooling press, the transfer time should be minimized to avoid warping of the PC. It has been determined that transfer time of less than about 600 seconds are acceptable. The cooling platens may have a temperature range of about 300° F. to about 32° F. Cooling temperature ranges from about 390° F. to about 65° F. may also be desirable. Ranges from about 250° F. to about 180° F. may also be utilized. If left in the cycle press for a sufficient period of time, the internal temperatures of the composite material will generally equal those of the platens, the ranges of which are given above. Final internal temperature of as high as 300° F., however, may be desirable to minimize warping of the composite sheet. Additionally, final internal temperatures of about 100° F., about 80° F., and about 70° F. have produced composite sheets displaying acceptable performance. The board is rapidly cooled under pressure to maintain its flatness. Due to its high polymer content, the board will usually warp if allowed to cool unrestrained using ambient air. Pressures applied by the platens in the heating press may range from about 150 psi to about 6000 psi or greater.

Table 2 presents the ranges of various components that may be utilized in composite formulations to produce acceptable PCs. Specifically, materials utilized may include colorants, wood filler, fire retardants, fiberglass, mold inhibitors, binders, and recycled carpet waste. The recycled carpet waste can be about 20% to about 98% of the total formula weight and still retain acceptable physical properties in the composite sheet. Certain embodiments may include carpet wastes in the amount of about 90% to about 98% total weight. Still other embodiments may include carpet wastes in the amount of about 94% to about 95% total weight. It has been found that composites that utilize approximately 95% carpet waste and about 5% binding agent produce a composite that exhibits satisfactory performance while being economically advantageous, due to the low cost associated with using recycled carpet waste versus virgin materials. In other embodiments, a 9:1 ratio of carpet waste to MDI, up to a 49:1 ratio of carpet waste to MDI may be utilized. Table 2 also presents percentages of additives, such as wood filler, color, fire retardant, fiberglass, and mold inhibitor that may be added to the binder/carpet waste mixture. The percentages of these additives may be up to those identified in Table 2, relative to the carpet waste/MDI content. Additionally, there is no discernible difference in the performance of the composite when using recycled carpet waste obtained from post-industrial carpet waste or post-consumer carpet waste, as compared with using virgin materials.

TABLE 2
Formulation Ranges for Composite Sheets.

Range

| Material | | Low % | High % |
|---|---|---|---|
| Carpet Waste | | 10 | 98 |
| Moisture Content | | 0 | 10 |
| Additives: | | | |
| Binders: | MDI | 2 | 20 |
| | UF | 2 | 20 |
| | MF | 2 | 20 |
| | PF | 2 | 20 |

| | | |
|---|---|---|
| Fly Ash | 0 | 80 |
| Added Calcium Carbonate | 0 | 80 |
| Slack Wax | 0 | 10 |
| Wood filler | 0 | 65 |
| Color | 0 | 25 |
| Fire Retardant | 0 | 25 |
| Fiberglass | 0 | 50 |
| Mold Inhibitor | 0 | 25 |

Tables 3 to 6 present formulations and performance parameters for PCs made in accordance with the cycle press process described above. Tables 3, 4, and 5 present this information for PCs made with different types of binding agents, but having the same total percentage of binding agents. The water absorption, thickness swell and moisture content testing was performed in accordance with the ASTM D1037-96A testing standard. The PC described in Table 3 is made with MDI and has higher modulus of rupture (MOR) and modulus of elasticity (MOE) values, with lower moisture absorption properties.

TABLE 3
Example 1 Formulations and Performance Properties.

| Material | | % |
|---|---|---|
| Carpet Waste | | 90.2% |
| Moisture Content | | 4.8% |
| Additives: | | |
| Binders: | MDI | 5.0% |
| | UF | 0.0% |
| | MF | 0.0% |
| | PF | 0.0% |

| | |
|---|---|
| Wood filler | 0.0% |
| Color | 0.0% |
| Fire Retardant | 0.0% |
| Fiberglass | 0.0% |
| Mold Inhibitor | 0.0% |
| total | 100% |
| Thickness (inch) | 0.250 |
| Density (pcf) | 53.3 |
| MOR (psi) | 1,866 |
| MOE (psi) | 80,331 |
| Tensile - Perpendicular [IB] | 728 |
| (psi) | |
| Tensile - Parallel (psi) | 14 |
| Linear Expansion | 0.10% |
| Thickness Swell (inch) | 0.002 |
| Thickness Swell (%) | 0.00% |
| Moisture Content (%) | 0.27% |

Table 4 presents information for a PC utilizing PF as the binding agent, that results in significantly lower, though still acceptable, MOR and MOE values.

TABLE 4
Example 2 Formulations and Performance Properties

| Material | | % |
|---|---|---|
| Carpet Waste | | 90.2% |
| Moisture Content | | 4.8% |
| Additives: | | |
| Binders: | MDI | 0.0% |
| | UF | 0.0% |
| | MF | 0.0% |
| | PF | 5.0% |

| | |
|---|---|
| Wood filler | 0.0% |
| Color | 0.0% |
| Fire Retardant | 0.0% |
| Fiberglass | 0.0% |
| Mold Inhibitor | 0.0% |
| total | 100% |
| Thickness (inch) | 0.250 |
| Density (pcf) | 48.0 |
| MOR (psi) | 971 |
| MOE (psi) | 49,600 |
| Tensile-Perpendicular [IB] | 716 |
| (psi) | |
| Tensile-Parallel (psi) | 58 |
| Linear Expansion | 0.54% |
| Thickness Swell (inch) | 0.007 |
| Thickness Swell (%) | 2.97% |
| Moisture Content (%) | 4.12% |

Table 5 presents information for a PC manufactured with a mixture of MDI and UF as binding agents. While this formulation displays performance characteristics higher than those listed for the Table 4 sample, the performance values are not as high as the sample using MDI as the binding agent, presented in Table 3.

TABLE 5
Example 3 Formulations and Performance Properties

| Material | | % |
|---|---|---|
| Carpet Waste | | 90.2% |
| Moisture Content | | 4.8% |
| Additives: | | |
| Binders: | MDI | 1.25% |
| | UF | 3.75% |
| | MF | 0.0% |
| | PF | 0.0% |

| | |
|---|---|
| Wood filler | 0.0% |
| Color | 0.0% |
| Fire Retardant | 0.0% |
| Fiberglass | 0.0% |
| Mold Inhibitor | 0.0% |
| total | 100% |
| Thickness (inch) | 0.250 |
| Density (pcf) | 45.4 |
| MOR (psi) | 1,359 |
| MOE (psi) | 66,716 |
| Tensile-Perpendicular [IB] | 1002 |
| (psi) | |
| Tensile-Parallel (psi) | 44 |
| Linear Expansion | 0.31% |
| Thickness Swell (inch) | 0.007 |
| Thickness Swell (%) | 2.78% |
| Moisture Content (%) | 3.02% |

Table 6 presents a composite sheet utilizing 25% wood filler, with double the amount of binding agent utilized in the Table 3 through Table 5 samples. Estimates of the performance properties of this sample utilizing wood filler are identified with an asterisk.

TABLE 6
Example 4 Formulations and Performance Properties

| Material | | % |
|---|---|---|
| Carpet Waste | | 60.0% |
| Moisture Content | | 5.0% |
| Additives: | | |
| Binders: | MDI | 10.00% |
| | UF | 0.00% |
| | MF | 0.0% |
| | PF | 0.0% |

| | |
|---|---|
| Wood filler | 25.0% |
| Color | 0.0% |
| Fire Retardant | 0.0% |
| Fiberglass | 0.0% |
| Mold Inhibitor | 0.0% |
| total | 100% |
| Thickness (inch) | 1.000 |
| Density (pcf) | 66.7 |
| MOR (psi) | 2,815 |
| MOE (psi) | 236,000 |
| *Tensile-Perpendicular [IB] | 1500 |
| (psi) | |
| *Tensile-Parallel (psi) | 100 |
| *Linear Expansion | 0.40% |
| *Thickness Swell (inch) | 0.010 |
| *Thickness Swell (%) | 3.00% |
| *Moisture Content (%) | 3.00% |

The differences in the performance properties of the above-identified examples indicate that the types and amounts of binders may be varied as desired to achieve acceptable results. Binder type and amount may be varied to effect cost or other properties. Although particular embodiments have not yet been tested, additives such as fire retardants may be added to produce a composite sheet having a Class A fire rating.

Example carpet waste composite boards have been manufactured using a cycle press. The operating conditions and settings for these examples are shown in Chart 1 below.

CHART 1

| Material— | | | | | | specific | Cure Time relative to |
|---|---|---|---|---|---|---|---|
| CW Fibers & | | MDI Resin/ | | Target | | Pressure | Thickness of Board |
| Agglomerated | Weigh-in | content | Humidity | Density | Designation of | [psi] | [seconds per |
| Pellets | [oz] | (2%-10%) | [%] | [pcf] | Presscycle | (limit) | Millimeter] |
| Fibers | 116.4 | 10% | 3 | 70 | m1239a20.20s | 580.125848 | 19 |
| Fibers | 116.4 | 5% | 3 | 70 | m1239a20.20s | 580.125848 | 19 |
| Fibers | 116.4 | 2% | 3 | 70 | m1239a20.20s | 580.125848 | 19 |
| Pellets/ | 123.4 | 10% | 5.2/2.94 | 70 | m1239a20.20s | 580.125848 | 19 |
| Fibers | | | | | | | |
| CW 1 | 49.7 | M 20 R | 2.77 | 55 | m0838a19.19s | 580.125848 | 19 |
| F | | | | | | | |
| Fibers | 51.1 | 5% | 2.9 | 55 | m0838a19.19s | 580.125848 | 19 |
| Fibers | 65.8 | 2% | 2.9 | 65 | m0838a19.19s | 580.125848 | 19 |
| Fibers/ | 91.0 | M 20 R | 2.72/3.95 | 55 | m1238a20.20s | 580.125848 | 19 |
| Pellets | | | | | | | |
| * | 114.6 | 10% | * | 68 | m1238a20.20s | 580.125848 | 19 |
| * | 107.6 | 10% | * | 68 | m1238a20.20s | 580.125848 | 19 |
| * | 215.1 | 10% | * | 68 | m2538a19.19s | 580.125848 | 19 |
| * | 215.1 | 10% | * | 68 | m2538a19.19s | 580.125848 | 19 |
| Pellets | 102.3 | 10% | 5.3 | 70 | m1239a20.20t | 290.062924 | 19 |
| Pellets | 74.1 | 7% | 5.3 | 50 | m1239a20.20t | 290.062924 | 19 |
| Pellets | 104.0 | 5% | 5.34 | 70 | m1239a20.20t | 290.062924 | 19 |
| Pellets | 72.3 | 2% | 5.63 | 50 | m1239a20.20t | 290.062924 | 19 |

| | | ‘Offset’ = a distance | | | |
|---|---|---|---|---|---|
| Material— | Temperature of | added to the press- | | | |
| CW Fibers & | Heating Plates | cycle mainly used to | Thickness | Density | |
| Agglomerated | [Degrees | adapt to the structure | of Board | of Board | |
| Pellets | Fahrenheit] | bleach (mm) | [inch] | [pcf] | Remarks |
| Fibers | 392 | 10 | 0.500 | 66.2 | Rough Woodstructure Pattern |
| Fibers | 392 | 8 | 0.492 | 69.9 | Rough Woodstructure Pattern |
| Fibers | 392 | 8.5 | 0.504 | 68.0 | Rough Woodstructure Pattern |
| Pellets/ | 392 | 6 | 0.476 | 78.0 | 3-Layer-Board Total Weights: |
| Fibers | | | | | Surface Layer = 40% Pellets, |
| | | | | | Core Layer = 60% Fibers |
| CW 1 | 392 | 11.5 | 0.287 | 54.1 | Area being Pressed (German abbr.: |
| F | | | | | Pr. Fl.) 300 mm * 300 mm |
| Fibers | 392 | 5.7 | 0.285 | 55.2 | ‘Fine’ (Wood) Structure |
| Fibers | 392 | 5.7 | 0.291 | 71.2 | ‘Fine’ (Wood) Structure |
| Fibers/ | 392 | 3.0 | 0.491 | 58.8 | 3-Layer-Board Total Weights: |
| Pellets | | | | | Surface Layer = 40% Fibers, |
| | | | | | Core Layer = 60% Pellets |
| * | 392 | 3.0 | 0.489 | 75.2 | * (same as above) |
| * | 392 | 3.2 | 0.520 | 66.0 | Cool down cycle within Press |
| | | | | | used for remainder |
| * | 392 | 3.2 | 0.998 | 68.2 | SL = 40% Fibers, CL = 60% |
| | | | | | Pellets (of total weight) |
| * | 392 | 3.2 | 1.020 | 67.7 | SL = 9% flbers, CL = 91% |
| | | | | | Pellets (of total weight) |
| Pellets | 392 | 6 | 0.496 | 68.7 | Smooth Surface |
| Pellets | 392 | 6 | 0.500 | 51.3 | Smooth Surface |
| Pellets | 392 | 6 | 0.496 | 69.9 | Smooth Surface |
| Pellets | 392 | 6 | 0.500 | 50.1 | Smooth Surface |

According to an alternative embodiment, the PC may be manufactured using a continuous roll process. The continuous roll press is a double belted press capable of maintaining a range of temperatures and pressures on the mat to allow the binding agent reaction and melting of select components to take place. The continuous roll press belts may be steel or other material. Process parameters for a continuous roll press are depicted in Table 7. Temperatures utilized are generally similar to those utilized in the cycle press process.

TABLE 7
Composite Sheet Processing Parameters (Continuous Roll Press)

Range

| | High | Low |
|---|---|---|
| Temperature of Heating Rolls | 600 | 100 |
| [° F.] | | |
| Pressure of Heating Rolls [psi] | 6000 | 150 |
| Internal Temperature of Board [° F.] | 500 | 340 |
| Temperature of Cooling Plates | 300 | 32 |
| [° F.] | | |
| Pressure of Cooling Rolls [psi] | 6000 | 150 |
| Internal Temperature of Board [° F.] | 300 | 70 |

For example, pressures from about 150 psi to about 6000 psi are used to squeeze the fiber mat to the desired thickness and density of the final product. The continuous roll press consists of a press structure that tensions the belts. In general, the press includes a number of frame units, depending on the length of the press and pressure that is required for a particular application. Cylinders arranged at the frame units in various combinations exert the desired pressure. The press includes top and bottom heated platens which roller rods and the belts travel over. The press has an infeed head to guide the roller rods, belts and mat to be pressed. The roller rods are located between the heated platens and the belts and support the mat as it is moved from one cylinder to the next. The belts are driven by two or more drums at generally opposite ends of the roll press. Drum scrapers may be used to keep the board from sticking to the belts. A release agent also may be sprayed onto the belts to keep the mat from sticking to the belts, allowing the composite to exit easily the press at the completion of forming. A control system regulates the operation of the press, such as the speed of the belts, temperature, pressure, thickness of the mat, etc.

The continuous roll press transfers heat to the binding agent-coated composite material. As the heat activates the coating, the cylinders press the mat together to achieve the desired thickness. Thus, while the mat material moves from the infeed section of the press, the mat's thickness is reduced while being heated to a temperature that ensures activation of the binding agent and melting of certain fibers. As the mat moves through the continuous roll press, the platens gradually reduce the thickness of the mat to a predetermined thickness. Depending on the amount of material introduced to the infeed section of the press, the density of the finished board is directly related to its final thickness.

In alternative embodiments, the mat and/or the finished board have a varying or non-uniform thickness, such as a taper to produce shingles, clapboards, or other products suitable for roofing or siding. For example, the thickness may vary from about 0.0625 inches to about 2.0 inches, or from about 0.125 inches to about 0.5 inches.

After the binding of the material and desired height dimension of the mat has been reached in a continuous roll press, a board is formed which is in the shape of a continuous ribbon. When the ribbon exits the press, it undergoes a continuous edge trimming operation to reach the desired width and then it is cross-cut to a pre-selected length. The ribbon is transported through the trimming and cross-cutting operations by a roller conveyor and pinch rollers. The cut boards are then transported to a cooling station. The cooling station can employ a variety of different machines such as a star cooler, with subsequent stacking, or a stacking roller conveyor. The star cooler is a large diameter wheel with multiple rows of spoked arms extending from the wheel. The arms lift each board from the conveyor and allow the boards to rotate with the wheel and be air cooled. If needed, the continuous roll press can have a cooling section with chilled rollers near the press outlet. This will cool the board (as described above) eliminating the need for further cooling. The board is then conveyed to a stacking operation and stored for future use. Alternatively the boards may be conveyed to a separate cooling press as described above. The boards are now ready to be shipped or they can go through a variety of decorating alternatives.

In a cycle press, the board can be manufactured to finished size or slightly oversized. If it is oversized, then it is cut to finish dimensions after it exits the press. The platens in the cycle press can have a patterned surface to give the board a structured surface such as a wood grain pattern. As the composite product exits the process as described above, it may be of varying thicknesses (e.g., tapered) having minimum and maximum thickness dimensions of any value in a range from less than ⅛ inch up to 2 inches or more. Since the last step in the process is the cutting to length of the composite product, the first step in finishing the product is cutting to final width.

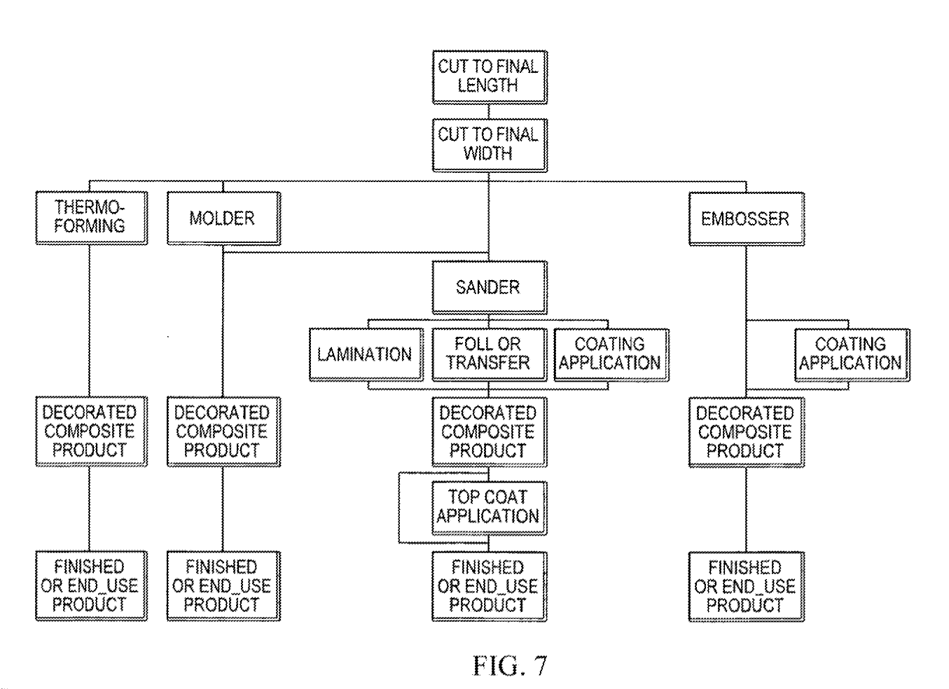

FIG. 7 shows the finishing and decorating steps that may be employed following cutting to final width, in accordance with an embodiment of the invention. Each of these finishing and decorating steps may also be utilized for PCs formed by extrusion, rather than by pressing and heating, as described below. The composite product can now be processed further to change the cross-sectional profile to take on the shape required in the finished product. The processing can be done on a variety of cutting machines of different designs, the most common of which is a molder using rotating knives. This machine allows for the setting of the knife blades to adjust the cut to the desired profile. Another common device is the router which cuts a specific groove or grooves (routs) into the surface of the composite product. The router has the same effect as the molder in that it changes the initial profile out of the process into the desired profile required for the final product.

The profile may also be changed using thermoforming methods. In this case, the composite product is placed in a mold of the desired profile and with heat and pressure the product takes on the shape of the mold. This profile change offers an additional decorating capability in that the desired color and/or pattern may be on a transfer foil placed in the mold. With the application of the heat and pressure during the process, the color and/or pattern are transferred from the carrier foil to the composite product. Thus, at the end of the thermoforming process, the composite product has the desired profile and also the desired decoration.

The composite product may be embossed after manufacturing. The embossing is accomplished with an embossing plate or roll. The plate or roll has the pattern to be transferred to the product on the surface of the plate or roll. This surface is heated to a temperature that will soften the surface of the composite product. Then the plate or roll is pressed onto the surface of the product to give the desired pattern transfer. As the surface of the composite product cools, the embossed pattern becomes fixed on the surface of the composite product. The embossed composite product is now ready to be coated, or if no coating is required for the end-use product, it is ready for packaging.

In certain embodiments, composite products that will be decorated first pass through a sander. This smoothing of the surface prepares the product for coating, transfers, and laminating. The sanded or embossed composite product may be coated with primers, finish paints, or stains. The coating application employs various conventional spray techniques using exhaust systems to remove the excess spray and solvents. Either penetrating or film-forming coatings may also be applied, and the choice is dependent on the desired finished product appearance and application. The sanded composite product can also act as a core to which decorative and protective layer(s) may be hot stamped from a foil or film or laminated to achieve improved physical and visual enhancement.

The composite product also may be decorated using transfer foils. Once again the product is first sanded to smooth the surface, then an adhesive layer is applied to the profile using a conventional application technique. The transfer foil has the desired color and/or pattern on a polymeric substrate, and is brought into contact with the surface of the product using stamping equipment designed for the specific application. Using heat and pressure, the color and/or pattern is transferred from the foil to the product. The heat required for the transfer activates an adhesive layer on the surface of the profile ensuring bonding of the decoration to the profile. With the color and/or pattern now on the composite product, the spent foil is then collected for disposal, and the finished product has the desired decorated effect.

Another decorating method that may be employed is lamination. Several materials may be used as the laminate surface, such as wood veneers, synthetic veneers, foils, films, and polymeric sheets. The application of rigid laminates like wood veneers is done using conventional laminating equipment. Generally, an adhesive system (either a wet adhesive system or a hot-melt adhesive system) employing a primer and an adhesive is applied to the PC substrate. The rigid surface laminate is then applied to the substrate and temperature and pressure are applied. After the temperature-pressure step, the laminated product is then set for a fixed period of time to allow the adhesive system to cure. In the case of the composite product, the composite product is the substrate. The adhesive system, usually a hot-melt adhesive, is applied to the composite product. The rigid veneer is then placed on the adhesive layer forming a sandwich of composite product, adhesive, and rigid laminate. The sandwich is then pressed to secure the bond of the laminate to the composite product. After curing the laminated product with the desired decorative appearance is ready for packaging.

Another laminating technique used with the composite product is foil laminating. This technique can be referred to as wrapping; wherein, the composite product profile is wrapped in the decorative foil. After the composite product profile has been sanded, the profile passes through a wrapping device that takes the foil wrap from a coil then applies the adhesive (and primer, if required) to the foil. In a continuous process, the foil wrap is then passed over the composite product profile. Using a series of rollers, the foil wrap is shaped to the composite product profile. The foil wrap may incorporate an integral topcoat material, such as polyurethane, acrylic, or other protective materials, for physical property enhancement. If, however, the foil wrap integrates only the decorative elements, then the wrapped composite product will require a separate topcoat for certain applications.

If the end-use product application requires significant surface property enhancements, such as abrasion resistance, a topcoat may be added to the decorating process. The topcoat can be polyurethane, acrylic, or other protective material that will impart better physical properties to the surface of the wrapped finished product. The topcoat may be spray applied or hot melt applied. If spray applied, the wrapped composite product will pass through a spray applicator and then may or may not pass through a curing device, such as an ultra-violet radiation station. If the topcoat is hot melt applied, then a layer of polyurethane is applied to flat surfaces of the decorated composite product. The cure process for this type of material is time dependent and could take several days depending on the hot melt topcoat chosen for a specific end-use application for the completed finished product. In another embodiment, the materials used for the topcoat are the same as those used for the capstock, described below.

### Formation of Extruded Carpet Waste Composites

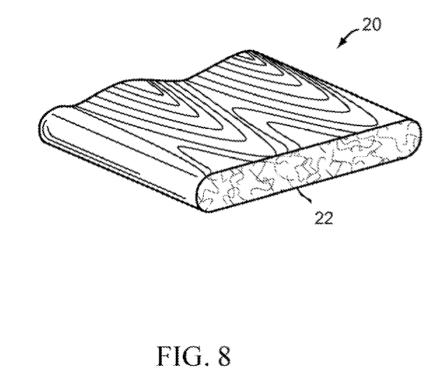

In certain embodiments, plastic composites are formed by mixing, heating, and extruding a carpet waste mixture in an extruder. FIG. 8 shows an extruded plastic composite 20 including recycled carpet waste formed in accordance with an embodiment of the invention. The extruded composite 20 generally comprises a dimensional composite body 22 formed from a mixture including one or more base polymers and, optionally, natural fibers. The base polymers may include polyethylene, HDPE, MDPE, polypropylene, LDPE, LLDPE, PVC, like materials, and combinations thereof. In certain embodiments, however, the base polymer may be replaced entirely by processed carpet waste (e.g., separated, unseparated, or de-calcified), as described in more detail below. The natural fibers or filler material help to provide the extruded composite 20 with the appearance and feel of a natural wood product. Types of natural fibers, such as wood fillers or the like, include wood chips, wood flour, wood flakes, sawdust, flax, jute, abaca, hemp, kenaf, rice hulls, like materials, and combinations thereof. In alternative embodiments, the composite includes fly ash and does not include any natural fibers.

In certain embodiments, the composite 20 also includes unseparated processed carpet waste, which can be blended or dispersed within the fiber-polymer compound, resulting in a PC of equivalent physical properties. The recycled carpet waste may be processed into a pelletized or powder form from post-industrial or post-consumer carpet waste. Depending on the composition of the carpet used, the recycled carpet waste can include wool, nylon, polyester, polypropylene, latex, jute, sisal, like materials, and combinations thereof. Due at least in part to processing controls, described in greater detail in the following paragraphs, the recycled carpet waste is dispersed and distributed throughout the extruded compound. Additionally, the composite 20 may include additives such as colorants, lubricants, flame retardants, mold inhibitors, compatiblizers, coupling agents, other materials, and combinations thereof. The composite may also include chemical foaming agents and may be capstocked. The relative amounts of components (i.e., filler, base polymer, recycled carpet waste, additives, etc.) may be modified as desired for a particular application. The various component amounts, ratios of components, and finished composite properties, are described in more detail below.

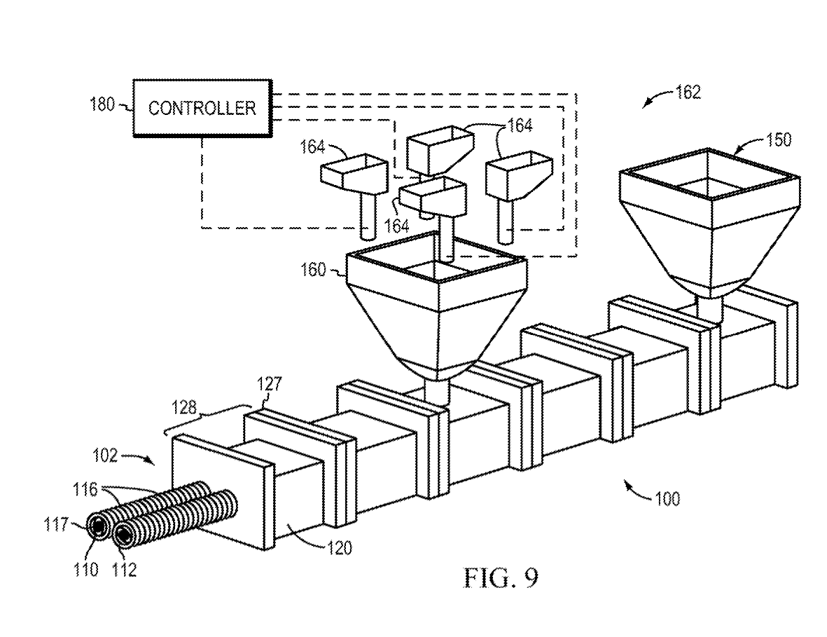

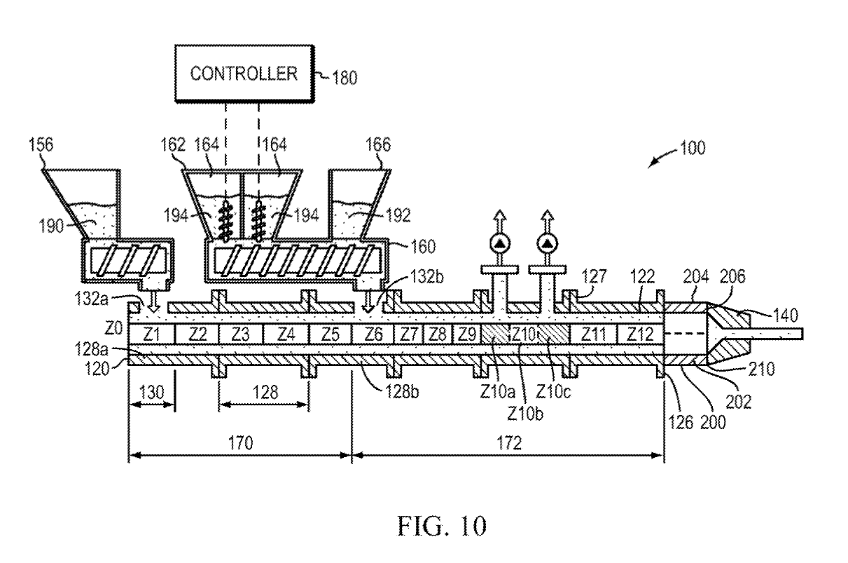

In certain embodiments, the invention includes systems for forming plastic composite extrusions. As shown in FIGS. 9 and 10, an extrusion system 100 includes at least four main stations, including: a supply station or primary feeder 150 that dispenses a base polymer (e.g., in the form of powders and/or pellets); a co-rotating twin screw extruder 102 arranged to receive the base polymer; a secondary side-feeder 160 that dispenses additional materials (e.g., filler materials such as wood or natural fibers, additives such as colorants, etc.) into the extruder 102 for mixing with the base polymer; and an extrusion die 140 for forming a composite extrusion with a predetermined profile.

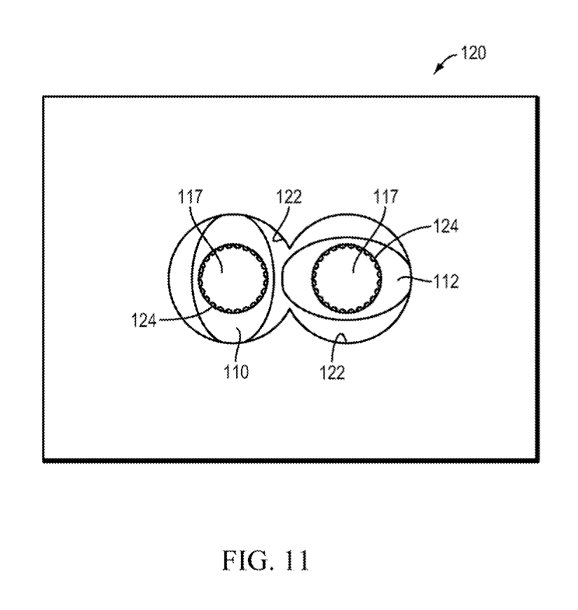

In the extrusion system 100 depicted in FIG. 9, the extruder 102 includes an extrusion barrel 120 and a pair of co-rotating extrusion screws 110, 112. The extrusion barrel 120 defines an internal cavity 122 (FIG. 11) where materials (e.g., base polymer, filler materials, additives, etc.) are mixed and conveyed. The extrusion barrel 120 is formed as an assembly including a plurality of discrete barrel segments 128. The barrel segments 128 are arranged in series, and together, form the internal cavity 122, which acts as a flow path between the supply station 150 and the extrusion die 140 (i.e., for conveyance of the various materials). The extrusion screws 110, 112 each comprise a plurality of discrete screw segments 116 sealed within the internal cavity 122 and extending from an upstream feed zone 130 to the extrusion die 140. The screw segments 116 are removable, replaceable, and interchangeable and can be arranged to achieve a desired feeding, conveying, kneading, and mixing sequence (referring to operations performed on the materials as they are conveyed through the extruder, along the internal cavity 122 of the extrusion barrel 120).

The extrusion screws 110, 112 are arranged in parallel relation and configured for co-rotational movement relative to each other. The co-rotational movement of the extrusion screws 110, 112 mixes materials, such as the base polymer, additives, etc., and conveys these materials through the extrusion barrel 120. Each of these components (i.e., extrusion barrel 120 and extrusion screws 110, 112) can be made of commercially available parts. A similar type of twin-screw extruder, wherein the screws rotate in a counter-rotational movement relative to each other, may also be used for the process. In a counter-rotational arrangement, the screws differ from the above co-rotational movement in that the mixing and dispersion are less intense and have a greater reliance of heat as opposed to shear mixing to achieve the compounding of all the ingredients.

As shown in FIGS. 9 and 10, the extrusion system 100 includes at least four main stations, including: a supply station 150; a co-rotating twin screw extruder 102; a secondary side-feeder 160; and an extrusion die 140. The supply station 150 can include a single and/or double screw (i.e., twin-screw) loss-in-weight gravimetric feeder for throughput of solid materials, i.e., typically in the form of fibers, powders, and/or pellets, into a feed zone 130 in the extruder 102. A loss-in-weight feeder or feeders with a maximum feed rate of between about 50 lb/hr and about 2000 lb/hr may be utilized. The feeder(s) also deliver materials directly into the extruder when the process is initially started.

Referring still to FIGS. 9 and 10, the twin screw extruder 102 includes: (i) an extrusion barrel 120; and (ii) a pair of co-rotation extrusion screws 110, 112. The extrusion barrel 120 comprises an assembly of discrete barrel segments 128 forming a substantially continuous series connection. This arrangement offers flexibility when compared to a counter-rotational extruder in that the individual barrel segments 128 can be moved, removed, and/or exchanged to provide different barrel configurations, e.g., to allow for different feeding (e.g., entry ports), vacuum, or injection locations. In addition, the segmented barrel configuration offers the flexibility of choosing between multiple entry ports (for example, as shown at 132a) into the extruder 102. For example, the use of more than one entry port can be employed to achieve a more sophisticated extruded product in terms of compound ingredients, product properties, and appearance. Each barrel segment 128 defines a barrel bore which, when assembled, forms a substantially continuous internal cavity 122 along the length of the extrusion barrel 120 (i.e., extending from the feed zone 130 toward the extrusion die 140). Each barrel segment 128 includes electrical heating elements, such as heating cartridges (not shown), and cooling bores (not shown) for counter-flow liquid cooling, together providing for optimizeable dynamic regulation and temperature control.

Individual barrel segments 128 are selected from open barrels (i.e., with entry ports for feed zones), open barrels with inserts (for degassing, metering, or injection zones), closed barrels, and/or combined barrels for combined feeding (e.g., side feeding of fibers or additives) and venting, each being between about 4 inches and about 20 inches in length. As shown in FIG. 10, the extrusion barrel 120 includes at least two open barrel segments 128a, 128b for fluid communication with the primary feeder 150 and the secondary side-feeder(s) 160, respectively. Preferably, a substantially leak-proof interface is formed at the interface between adjacent barrel segments 128. Adjacent barrel segments 128 can be connected, e.g., with bolted flanges 127, as shown in FIG. 9, or, alternatively, C-clamp barrel connectors (not shown).

Referring to FIG. 9, the co-rotating extrusion screws 110, 112 provide for a relatively efficient type of extruder in terms of its ability to disperse and distribute materials within a matrix of extruded materials. As shown, each of the extrusion screws 110, 112 comprises a segmented screw arrangement, wherein each of the extrusion screws 110, 112 include a series of discrete elements (i.e., screw segments 116) fit onto a shaft 117. Teeth 124 (see FIG. 11) allow the individual segments 116 to be secured to the shaft 117. Suitable screw segments are commercially available from ENTEK Manufacturing, Inc., of Lebanon, Oreg. The individual screw segments 116 are each removable and replaceable and may be selected to have contrasting screw profiles, thus allowing for a flexible screw profile arrangement that can be tailored to specific applications and/or process requirements.

Among the various types of screw segment profiles, the individual segments can be selected from conveying elements, mixing elements, kneading elements, and/or special elements. Mixing and kneading elements are designed in a variety of lengths, pitches and pitch directions. Kneading blocks are constructed using several sub-segments of equal or varying widths spaced at equal distances from each other. The order in which kneading, mixing, conveying, and other segments may be arranged to control shear, melt, and energy. In addition, this mixing process provides homogeneous melt and controlled dispersion-distribution of the recycled carpet waste and other additives. The segmented screws 110, 112 allow for modification of the screw profile, e.g., for modification of processing parameters, varying physical properties, and/or surface appearance of the extruded product. Generally, an overall diameter of the screw segments remains constant; however, the shape of flights (e.g., pitch and distance between flights) can vary.

The screw segments 116 can be arranged so that about a first half of the extruder 102 provides relatively high shearing and kneading (i.e., for dispersive mixing of the base materials including the recycled carpet waste) and about the second half of the extruder 102 provides relatively low shearing (i.e., for distributive mixing of the composite material and colorants). This arrangement can be used to inhibit overmixing of the one or more polymers and additives that form the polymeric portion of the composite material.

In one exemplary embodiment, each of extrusion screws 110, 112 comprises fifty-two (52) discrete screw segments 116, each between about 60 mm and about 120 mm in length. This particular configuration defines twelve (12) processing zones Z1-Z12, each zone comprising a change in screw profile defined by one or more discrete screw segments (see, e.g., FIG. 11 and Table 8). In this embodiment, the screw segments 116 are arranged such that the first five zones (Z1-Z5) form a first mixing region 170 configured for dispersive mixing (i.e., relatively high kneading and shearing), and the last seven zones (Z6-Z12) form a second mixing region 172 configured for distributive mixing (i.e., relatively low shearing). In dispersive mixing, cohesive resistances between particles can be overcome to achieve finer levels of dispersion; dispersive mixing is also called intensive mixing. In other words, dispersive mixing includes the mixing and breaking down of discrete particles within the compound. Distributive mixing aims to improve the spatial distribution of the components without cohesive resistance playing a role; it is also called simple or extensive mixing. Distributive mixing allows for division and spreading of discrete particles into a mixture without substantially affecting the size and/or shape of the particles (i.e., no breaking down of the particles).

Table 8 identifies typical zone temperatures and other details regarding the extruder processing system employed in the various embodiments of the invention. Temperatures for each zone, in a high/low range, are presented. Notably, the ranges presented may be utilized to produce both PCs containing carpet waste and those containing no carpet waste. Additionally, the ranges presented may also be utilized to produce PCs that utilize unseparated processed carpet waste in place of the base polymer (i.e., unseparated processed carpet waste comprises up to 100% of the total plastic component of the finished composite material), and/or to produce composites that utilize no wood at all, but are comprised of recycled carpet waste, additives, and (optionally) virgin base polymer. Examples of PCs containing carpet wastes manufactured in accordance with the ranges exhibited in Table 8 are described below. Temperature and other ranges outside of those depicted are also contemplated.

TABLE 8
Processing Parameters for Composites Including Carpet Waste

| | Melt Pump Inlet | | Melt Pump Outlet | | Extruder | Melt | Polymer | Wood | Added |
|---|---|---|---|---|---|---|---|---|---|
| | Mat'l Temp | Pressure | Mat'l Temp | Pressure | Speed | Pump | Feed | Feed | Wax |
| | P.A.I. deg C. | Bar | deg C. | Bar | rpm | rpm | lb/hr | lb/hr | lb/hr |
| High | 180 | 18 | 180 | 18 | 350 | 25 | 2200 | 1000 | 10 |
| Low | 150 | 7 | 150 | 7 | 250 | 15 | 960 | 900 | 0 |

| | Zone 0 | Zone 1 | Zone 2 | Zone 3 | Zone 4 | Zone 5 | Zone 6 | Zone 7 | Zone 8 | Zone 9 | Zone 10 | Zone 11 | Zone 12 |
|---|---|---|---|---|---|---|---|---|---|---|---|---|---|
| | Set | Set | Set | Set | Set | Set | Set | Set | Set | Set | Set | Set | Set |
| | deg C. | deg C. | deg C. | deg C. | deg C. | deg C. | deg C. | deg C. | deg C. | deg C. | deg C. | deg C. | deg C. |
| High | 60 | 240 | 240 | 240 | 240 | 190 | 180 | 165 | 155 | 140 | 135 | 125 | 120 |
| Low | 40 | 190 | 190 | 190 | 190 | 180 | 170 | 155 | 145 | 130 | 125 | 115 | 110 |

| | Adapter | Melt Pump | Y-block 1 | Y-block 2 | Y-block 3 | Die L1 | Die L2 | Die L3 | Die R1 | Die R2 | Die R3 |
|---|---|---|---|---|---|---|---|---|---|---|---|
| | Set | Set | Set | Set | Set | Set | Set | Set | Set | Set | Set |
| | deg C. | deg C. | deg C. | deg C. | deg C. | deg C. | deg C. | deg C. | deg C. | deg C. | deg C. |
| High | 155 | 155 | 155 | 155 | 155 | 155 | 155 | 155 | 155 | 155 | 155 |
| Low | 140 | 140 | 140 | 140 | 140 | 140 | 140 | 140 | 140 | 140 | 140 |

In general, conveying and feed elements (e.g., Z1, Z2, Z4, Z6, Z8, Z10, and Z12) serve to displace material through the extrusion barrel 120, from the first entry port 132a towards the extrusion die 140. Kneading blocks (see, e.g., Z3 and Z6) provide for high shear and dispersing (e.g., of base materials). Mixing elements (see, e.g., Z7, Z9, and Z11) provide for relatively high particle distribution (e.g., high distribution of fiber materials). Zones having a flight pitch less than 90° provide for compression of materials. Zones having a flight pitch of about 90° provide for frictional heating of the materials while providing little if any aid in the conveyance of the material. Zones having a flight pitch exceeding 90° provide for relatively high conveyance.

Referring to FIGS. 10 and 11, and Table 8, zone Z0 is the ambient temperature. Zones Z1 and Z2 are configured for moving materials from the throat of the extruder 102 and heating it before it is introduced to zone Z3. More specifically, the first processing zone Z1 is configured to move cold material, e.g., a mixture of pelletized base materials, from an entry point at ambient temperature, i.e., main entry port 132a, toward the second processing zone Z2. The second processing zone Z2 is configured to increase pressure on the material as it is moved forward in the direction of the third processing zone Z3. The first eight to twenty-four segments making up the second processing zone Z2 have a flight pitch of about 90°. In this portion, conveyance is achieved primarily through the introduction of additional material from the first processing zone Z1, which results in the build up of pressure in the second processing zone Z2, which, in turn, forces the material through the second processing zone Z2.

Processing zones Z3-Z5 define a high shear section. In this section the base materials are thoroughly dispersed into a molten composite mixture. Zone Z6 marks a transition to the distributive mixing region 172. This is the zone in which the fibers (as fillers) and some additives are added to the molten composite mixture. The greater flight pitch of 120° in this zone provides for increased conveyance along or about zone Z6, i.e., this zone moves materials along quickly, thereby inhibiting cooling-off of the materials. Zones Z7-Z9 are configured to provide high distribution mixing of the fiber filler material with the molten composite mixture. The tenth processing zone Z10 includes six to twelve discrete screw segments. These segments define a first section Z10a of relatively high compression; followed by a section Z10b of relatively low conveyance, which allows the material to expand, allowing moisture to rise to the outer surface where it can evaporate; and a second section Z10c of relatively high compression.

The eleventh processing zone Z11 is a mixing zone with a relatively high flight pitch, which provides for increased conveyance and subtle mixing. The twelfth processing zone Z12 transitions from a first section of relatively high conveyance (i.e., this zone moves material at a relatively high flow/feed rate to inhibit cooling prior to entering the die) to a second section of relatively high compression, which provides for a build-up of pressure near the distal end 126 of the extruder 102, for forcing the material through the extrusion die 140.

Referring again to FIGS. 9 and 10, one or more secondary side-feeders 160 are provided for dispensing one or more additional materials (e.g., filler materials or natural fibers, recycled carpet waste, colorants, and/or other additives) into the extrusion barrel, i.e., for mixing with the base polymer. The secondary side-feeders 160 move the materials into the extruder 120 through a second side entry port 132b using, e.g., a single-screw or double-screw configuration. As shown in FIG. 10, the secondary side-feeder 160 can include one or more loss-in-weight gravimetric feeders 166 for dispensing fibers and recycled carpet waste and a multiple feeder array 162, such as volumetric auger feeders, for dispensing multiple colorants (or other additives) into the extruder. Thus, two, three, four or more additives may be added from individual hoppers 164 to the extrusion process.

The secondary side-feeder 160 can be disposed in a position downstream of the primary feeder 150 (where the base polymer is introduced) and the first mixing region 170, such that the filler materials, recycled carpet waste, and additives are dispensed into the extruder 102 for mixing with the base polymer in the second (relatively low kneading and shear) mixing region 172. Introduction of the filler material, unseparated processed carpet waste, and additives at a common zone may present particular advantages. For example, the downstream shearing and kneading effect of the extrusion screws 110, 112 on the fibers and additives is less than the upstream effect on the base materials, thereby providing a thoroughly mixed composite material (i.e., including the base polymer, recycled carpet waste, and filler materials). Alternatively or additionally, recycled carpet waste can be introduced at the primary feeder 150, between the primary feeder 150 and the secondary side-feeder 160, or the downstream of the secondary side-feeder 160. Alternatively, in embodiments of the composite where unseparated processed carpet waste replaces higher amounts of base polymer (i.e., up to about 100% o the base polymer), the carpet waste may be introduced in the primary feeder 170.

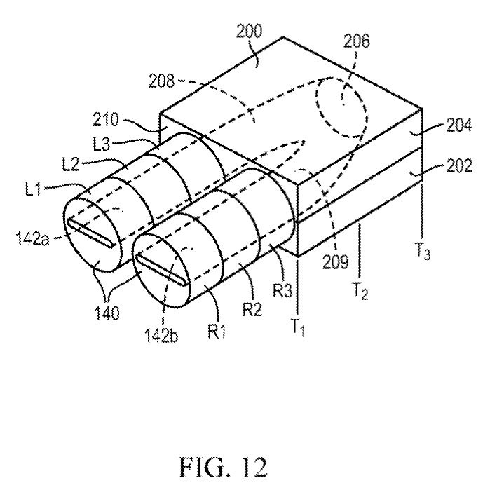

As shown in FIG. 12, the system may include a Y-block adapter 200 disposed at a distal end 126 of the extruder 102. The Y-block adapter 200 includes two adapter segments 202, 204 divided into three temperature zones, approximately defined by locations T1, T2, T3. Heating is performed by heating cartridges (not shown). The Y-block adapter 200 defines a flow channel 206, which divides flow from the internal cavity 122 of the extrusion barrel 120 into two discrete flow paths 208, 209.

The system 100 also includes an extrusion die 140 disposed at a distal end 210 of the adapter 200. The extrusion die 140 may define a pair of extrusion channels 142a, 142b, each corresponding to an associated one of the flow paths 208, 209, for forming, in tandem, a pair of extruded products (i.e., extrudates) each having a predetermined shape (i.e., corresponding to a shape of the extrusion channels 142a, 142b). Each of the extrusion channels 142a, 142b comprises three (or more) discrete segments L1-L3, corresponding to 142a, and R1-R3, corresponding to 142b. These discrete segments L1-L3, R1-R3 smoothly transition the geometry of the flow paths 208, 209 along the extrusion channels 142a, 142b to prevent introduction of air bubbles, creation of high pressure areas, etc. Each of L1-L3 and R1-R3 comprise discrete temperature zones and are heated using individual heaters.

Referring again to FIG. 10, a base mixture 190 including a base polymer (in one embodiment, a polyethylene mixture including, for example, virgin high density polyethylene (HDPE), recycled HDPE, and/or reprocessed HDPE), recycled carpet waste, and other additives (e.g., base colorant(s), internal processing lubricants, flame retardants, etc.), generally in the form of solid particles, e.g., powders and/or pellets. In one embodiment, the base mixture 190 is dispensed from the supply station 150 into the feed zone 130 of the extruder 102 at a total feed rate of between about 400 lb/hr to about 2000 lb/hr. Other suitable base polymers include polypropylene, medium density polyethylene, low density polyethylene, linear low density polyethylene, and PVC, when using a counter-rotational twin-screw extruder. The base mixture 190 is heated by electrical heating elements, and dispersed (i.e., the polymer particles and additive particles are mixed and broken down) as it is conveyed through the extrusion barrel 120 from the feed zone 130 towards the extrusion die 140 with the extrusion screws 110, 112 at a feed rate of between about 400 lb/hr and about 2000 lb/hr.

As mentioned above, the extrusion screws 110, 112 define twelve discrete processing zones Z1-Z12, wherein the first six processing zones Z1-Z6 form a first mixing region 170 (for relatively high kneading and shearing) and the last six zones Z7-Z12 form a second mixing region 172 configured for relatively low shearing and mixing. High and low temperatures used in various embodiments of the invention are exhibited in Table 8, although higher or lower temperatures than those depicted are contemplated. As shown in Table 8, the base mixture 190 is heated from a temperature of about 60° C. (ambient, at zone Z0) to about 240° C. as it is conveyed along the first four (i.e., Z1-Z4) of these processing zones, and gradually cooled before exiting the first mixing region 170, thereby forming a thoroughly mixed molten plastic material. At this point in the process, the molten material is a composite of the base polymer, i.e., high density polyethylene, recycled carpet waste, and additives.

Still other materials, such as filler materials (wood or natural fibers) and colorants may be added to achieve the desired physical properties and appearance effects. The wood or natural fibers may give the resultant PC the desired stiffness, rigidity, appearance, or other properties required of a commercially successful replacement product. The colors are for appearance effects.

Referring again to FIG. 10, a plurality of natural fibers 192, such as, for example, wood fibers, hemp, kenaf, abaca, jute, flax, and ground rice hulls, and one or more additives, may be metered into the extruder 102 through the one or more secondary side-feeders 160 for mixing with the molten composite materials. In one embodiment, the natural fibers 192 and additives 194 are introduced into the extruder 102 in an area proximate the sixth processing zone Z6. The fibers 192 and additives/colorants 194 are then mixed with the molten material 190 as it is conveyed through the second (relatively low shearing) mixing region 172. As the molten composite is conveyed along about the tenth processing zone Z10, it is first compressed under vacuum of about 29 in-Hg; then the material is allowed to expand, allowing moisture to rise to an outer surface for evaporation; the material is then compressed again under vacuum of about 25 to about 29 in-Hg. This transition region Z 10 removes moisture as the material is conveyed toward the extrusion die. The screw segments 116 are selected as described in greater detail above, to provide high distribution of the fibers 192 in the composite material 190, while at the same time inhibiting over mixing of the colorants 194 with the composite material. In this embodiment, the natural fibers 192 are metered into the extruder 102 at a rate of about 400 lb/hr to about 2000 lb/hr. The additives that may be introduced at this point into the extruder are usually much smaller in quantity, being in the range of 5 lb/hr to about 50 lb/hr. The exceptions being molder and/or cutter trim, which may be added at rates of about 50 lb/hr to about 300 lb/hr; and recycled carpet waste which may be added at rates of about 50 lb/hr to about 500 lb/hr. In addition to adding additives at the secondary side feed 160, unseparated processed carpet waste may also be added at this location, if desired.

All the feeders, both for the main entry port and for secondary port(s) are controlled through a programmable logic controller 180. The amounts of each material added are controlled for optimum formulation control allowing for the use of specific materials at specific amounts. These feeder controls thus control the physical properties of the extruded composite product.

The composite material is gradually cooled from the temperature when exiting the first mixing region 170 to a temperature of about 170° C. to about 180° C. as it is conveyed along the second mixing region 172 towards the extrusion die 140. This cooling allows the fibers 192 to mix with the molten composite material 190 without being destroyed by the process temperatures. The material is compressed as it is conveyed from zone Z11 to zone Z12, thus allowing pressure to build-up, e.g., between about 50 bar to about 90 bar at the extruder exit, in order to force the material through the die. In one embodiment, an adapter and melt pump are located at the distal end 126 of the extrusion system 100. The melt pump levels pressure within the system 100 and increases speed of the extruded material. Table 8 also depicts the temperature and pressure ranges of the material at the melt pump. The composite material is then fed into the Y-block adaptor (if present) where it is heated to a temperature of about 155° C. and split into two separate flows, which are forced through corresponding extrusion ports 142a, 142b of the extrusion die 140 to form a pair of extruded composite parts.

Introduction of the recycled carpet waste into the plastic composite is facilitated, at least in part, by the retention of the processability in the extruder, the capability to withstand the downstream (of the extruder) mechanical functions and the resulting physical properties. The goal of substantially replicating the properties of existing PCs is initially controlled by the formulation including the base polymer, the fiber, the additives, and the unseparated processed carpet waste.

Table 9 depicts the ranges of various components that may be utilized in composite formulations in accordance with the present invention. Specifically, materials introduced via the main feed may include HDPE pellets (as a base polymer), lubricants, colorants, and recycled carpet waste (CW-1P, post-industrial waste, and CW-2P, post-consumer waste). Other components, such as regrind (in pulverized or flake form) and repro, to replace at least a portion of the HDPE pellets used in the base polymer, also may be introduced via the main feed. The regrind material is post-industrial or post-consumer polyethylene materials or combination of the two. The repro is reprocessed extrusion materials generated in the production of the extruded product. The side feed, located downstream from the main feed, may be utilized to introduce wood filler (maple, oak, or combinations thereof, and other wood species), colorants, recycled carpet waste, and lubricants. Also included is a baseline composite formulation, including defined amounts of HDPE pellets, colorant, filler, and lubricant, that does not include any recycled carpet waste.

TABLE 9
Formulations for Extruded Composites

Range

| Material | Low % | High % |
|---|---|---|
| Main Feed | | |
| HDPE Pellet | 0 | 45 |
| Regrind (Pulverized) | 0 | 12 |
| Regrind (Flake) | 0 | 12 |
| Repro | 0 | 6 |
| Lubricant* | 4 | 7 |
| Color | 1 | 2 |
| CW-1 | 1 | 60 |
| CW-2 | 1 | 60 |
| CW-1/CW-2** | 1 | 96 |
| Side Feed | | |
| Wood Filler | 0 | 80 |
| Color | 1 | 2 |
| CW-1 | 1 | 60 |
| CW-2 | 1 | 60 |
| Lubricant* | 4 | 7 |

*Lubricants: separate addition of zinc stearate and EBS wax or addition of specialty lubricant Struktol 104.
**Elevated percentages of carpet waste are utilized when virgin base polymer approaches 0% of the total composite formulation

It has been discovered that, surprisingly, the recycled carpet waste formulations produce an extruded product having performance and appearance characteristics essentially the same as the standard plastic composite, and can be processed in the extruder using the same screw profiles and zone parameters. Further, the ratio of wood fiber to total HDPE remains substantially constant and the recycled carpet waste is added to the fixed wood fiber/HDPE compound. Two specific examples of PCs manufactured in accordance with the component ranges of Table 9 and the process ranges of Table 8 are depicted in Tables 11 and 12. Ratios of the base polymer to filler material for PCs that utilize recycled carpet waste may range from 40:60 to 60:40, and still exhibit suitable acceptable performance. Certain embodiments have a base polymer to filler material ratio of about 45:55. In some embodiments, the filler material may comprise about 0% to about 80% of the total formula weight; in other embodiments filler material comprising about 18% to about 55% may be preferable. Notably, filler material is not necessarily required, and in certain applications where the finished product is subject to high moisture exposure, it may be desirable to exclude filler material entirely. All of the additives remain in substantially constant compound ratios with the exception of the lubricant, which is adjusted to account for the larger total compound weight when the unseparated processed carpet waste is added.

As shown in Table 9, the HDPE base polymer may be eliminated entirely and separated or unseparated carpet waste, such as CW-1 or CW-2, may be used as the base polymer. In this usage of the carpet waste, the wood fiber filler (or other fiber fillers) is balanced to the base polymer, made of carpet waste, to obtain the desired physical properties and extrusion characteristics. Surprisingly, with carpet waste as the base polymer, the composite can be processed with similar methods used for conventional PCs, and similar physical properties of the end products may be realized.

Table 9 illustrates the range of individual components that may be used to produce acceptable PCs. It is shown that the recycled carpet waste can be added from about 1% to about 96%, or about 1% to about 60%, of the total formula weight, whether or not an HDPE base polymer is being utilized, and still retain acceptable physical properties in the extruded component. Alternative embodiments may include recycled carpet waste from about 1% to about 96% of the total formula weight. Certain embodiments may include carpet wastes in the amount of about 10% to about 40% total weight. Still other embodiments may include carpet wastes in the amount of about 15% to about 25% total weight. Further, as discussed above, the recycled carpet waste can be added to the composite formulation at various ports on the extruder. Specifically, Table 9 exhibits the addition of the recycled carpet waste into the composite with or without the base polymer. In cases when the recycled carpet waste is used in the smaller percentages of the total formula, the recycled carpet waste may be added through a side-feed entry into the extruder. There is no discernible difference in the extruded product when adding the recycled carpet waste resulting from the use of selvedge (CW-1), or mixed post-consumer carpet waste (CW-2). Further different types of lubricant perform equally well in the processing. For example, where both a “one-pack” or combined specialty lubricant is used as well as mixed lubricant package (e.g., Zinc Stearate, EBS wax, etc.), the invention processed acceptably regardless of the lubricant approach to formulating. Within the ranges of components depicted in Table 9, certain formulations have proven particularly desirable for commercial purposes. One such embodiment of the composite material is comprised of the following: about 31.3% HDPE, about 20.0% unseparated processed carpet waste, about 40.9% natural fiber, about 6.4% lubricant, and about 1.4% color.

Embodiments of the composite material wherein unseparated processed carpet waste comprises up to 100% of the base polymer are also contemplated and have been achieved. In such embodiments, the amount of virgin base polymer material will be substantially reduced or eliminated, and unseparated processed carpet waste can comprise the entire plastic component of the composite material. As described herein, unseparated processed carpet waste may be effectively mixed with base polymer to produce composite materials. It has been discovered, however, that small amounts of HDPE may not mix well with unseparated processed carpet waste, if that carpet waste contains a high percentage of non-polyolefin polymers such as polyamides. This could lead to performance issues in products made with these components, including the potential for delamination of the finished product. When processing unseparated processed carpet waste into a composite material, temperatures higher than the melt temperature of HDPE should be utilized to process the carpet waste. However, the small amounts of HDPE introduced into the carpet waste simply may not typically be mixed properly with carpet waste having high percentages of non-polyolefin material. It is believed that this may be a function of the dissimilarity between the non-polyolefin material (of the carpet face fibers) and the virgin HDPE, wherein the non-polyolefin material exhibits non-compatibility with the HDPE sufficiently to allow for a consistent mixture. Further study has shown that composite formulations utilizing unseparated processed carpet waste having high percentages of polypropylene face fibers and smaller amounts of virgin polypropylene may not experience this condition. Accordingly, coupling agents or other compatibilizers, such as maleaic anhydride polypropylene (MAPP), may be utilized to improve the processability of the mixture and performance of the finished product.

As depicted in Table 9, embodiments of the PC utilizing unseparated processed carpet waste as the base polymer may comprise between about 1% to about 96% by weight carpet waste, preferably about 50% to about 80% by weight carpet waste, more preferably between about 55% to about 70% carpet waste, and even more preferably, about 60% to about 65% carpet waste. The remainder of the composition may be comprised of additives (about 10%), inorganic fillers (e.g., fly ash), and/or natural fibers (about 10% to about 40%). One formulation that displays desirable processing characteristics includes about 60.9% unseparated processed carpet waste, about 30% natural fibers, about 4.6% lubricant, about 3.0% color, and about 1.6% zinc borate (a mold inhibitor). Another embodiment includes about 59.0% unseparated processed carpet waste, about 30% natural fibers, about 4.6% lubricant, about 3.8% color, about 1.6% zinc borate, and about 1.0% coupling agent.

Examples of the processing conditions of the extruder are shown in Table 8. The variability of the processing temperatures and pressures is quite wide. As an example, the maximum temperature of the barrel may vary from about 190° C. to about 240° C. At the same time, the pressure exiting the extruder may vary from about 8 bar to about 30 bar. Similarly, the internal pressure in the die(s) depends on whether the extrusion is being done on a single die or double die arrangement. On a single die the extruded product in the invention processes at about 1 bar to about 15 bar. The same formulation will process through a double die arrangement at about 30 bar to about 90 bar. It has been discovered that, surprisingly, the temperatures of the barrel segments and the pressures at both the extruder exit and in the die for the recycled carpet waste composite are similar to standard plastic composite processing parameters.

It has also been discovered that plastic composites containing recycled carpet waste process equally well on different sizes of extruders. Specifically, the material performs similarly on a 53 mm extruder as it does on a 103 mm extruder. A wide range of processing temperatures allow for the production of an acceptable extruded product.

The downstream mechanical operations, beyond the extruder die arrangement, follow the same pattern as the formulation and processing conditions, in that, the composite containing the recycled carpet waste has minimal effect on processing of the final product relative to the conventional plastic composite. The extruded product containing the recycled carpet waste can be cut using conventional traveling saw or other equipment. Likewise, the extruded board can be molded and/or embossed using standard equipment. In the case of molding, a blade cutter is used to change the surface appearance to a grooved or sanded appearance. The performance of this equipment for this downstream process step is unchanged when the formulation with the recycled carpet waste is introduced. These formulations incorporating the recycled carpet waste also are capable of being hot surface embossed. An embossing roll using either an internal hot oil system to heat the surface of the embossing roll or an infra-red heating system to heat the roll surface both emboss the board containing the recycled carpet waste. There is no difference when running formulation with or without the recycled carpet waste.

Similar to the other downstream operations, the application of a coextruded capstock is as effective with the recycled carpet waste product as with conventional PC products. The same coextrusions die setup may be employed with the recycled carpet waste, and the setup may be effective at similar rates, temperatures, and internal pressures.

In certain embodiments, composite formulations containing recycled carpet waste give equivalent flexural strength and stiffness to the standard composites. Upon extrusion and cooling, the finished composite materials may be tested and inspected to ensure acceptable performance and geometry. Multiple parameters may be evaluated, including visual appearance, dimensional control, physical properties, water absorption, etc.

Visually, the composites are inspected for cracks along the edges or gaps within the material internally (the composites may be cut, bored, etc., to confirm consistency of distribution of the recycled carpet waste and other materials). Dimensional control inspections determine whether the composites adequately resist warping, bending, or twisting. Samples may be tested, for example under ASTM-D790, to determine specific physical properties, such as stress, displacement, modulus of elasticity, and load. As indicated below, Examples manufactured with recycled carpet wastes as described herein display similar properties to PCs lacking recycled carpet wastes.

Examples made with recycled carpet waste as described herein also display particular resistance to water absorption when subjected to the FCQA Water Absorption Test. In certain embodiments, absorption amounts of not more than about 10% by weight are obtained; amounts of not more than about 7% by weight may also be obtained. As shown in Tables 10, 11, and 12, the various Examples exhibit improvement in the moisture absorption of the finished extruded product as recycled carpet waste is added to the composite formulation.

Comparative Example 1, depicted in Table 10, is a PC manufactured in accordance with the processes described herein, but without the use of recycled carpet waste. As can be seen, Comparative Example 1 fails at 617 lbf, with a displacement at failure of 2.437 inches. The water absorption is approximately 10.3% weight of Comparative Example 1.

TABLE 10
Comparative Example 1

| | |
|---|---|
| FC | FC |

6524A

| Material | lb. | % |
|---|---|---|
| Main Feed | | |
| HDPE Pellet | 246.0 | 42.0 |
| Regrind (Pulverized) | 0.0 | 0.0 |
| Regrind (Flake) | 0.0 | 0.0 |
| Repro | 0.0 | 0.0 |
| Struktol 104 | 0.0 | 0.0 |
| Color | 12.0 | 2.0 |
| CW-1P | 0.0 | 0.0 |
| CW 2P | 0.0 | 0.0 |
| Side Feed | | |
| Wood Filler | 300.7 | 51.3 |
| Color | 0.0 | 0.0 |
| CW-1P | | 0.0 |
| CW-2P | | 0.0 |
| Struktol 104 | 27.0 | 4.6 |
| Formulation Weight | 585.7 | 100.0 |
| Rate, lb./hr. | 800 | |
| Stress, psi | 3001 | |
| Displ., in. | 2.437 | |
| MOE, psi | 601704 | |
| Load, lbf | 617 | |
| Water Absorption, % wt | 10.3 | |

Example 1 depicts an exemplary PC manufactured with 15.7% post-consumer carpet waste. As can be seen, although the total weight of HDPE pellet and wood filler remains consistent with that utilized in Comparative Example 1, the use of recycled carpet waste effectively decreases the percentage of those components within Example 1. The use of recycled carpet waste results in Example 1 failing at 633 lbf, with a displacement at failure of 2.244 inches. The physical mechanism responsible for this decrease in displacement at failure, as compared to the Comparative Example 1, is the subject of further study. Notably, however, the water absorption of Example 1 is considerably lower than that of the Comparative Example 1, as the increased amount of recycled carpet waste effectively decreases the percentage of wood filler within Example 1.

TABLE 11
Example 1

| | |
|---|---|
| FC | FC |

6524C

| Material | lb. | % |
|---|---|---|
| Main Feed | | |
| HDPE Pellet | 246.0 | 35.1 |
| Regrind (Pulverized) | 0.0 | 0.0 |
| Regrind (Flake) | 0.0 | 0.0 |
| Repro | 0.0 | 0.0 |
| Struktol 104 | 0.0 | 0.0 |
| Color | 12.0 | 1.7 |
| CW-1P | 0.0 | 0.0 |
| CW 2P | 110.0 | 15.7 |
| | | 0.0 |
| Side Feed | | |
| Wood Filler | 300.7 | 42.9 |
| Color | 0.0 | 0.0 |
| CW-1P | | 0.0 |
| CW-2P | | 0.0 |
| Struktol 104 | 33.0 | 4.7 |
| Formulation Weight | 701.7 | 100.0 |
| Rate, lb./hr. | 800 | |
| Stress, psi | 3060 | |
| Displ., in. | 2.244 | |
| MOE, psi | 556635 | |
| Load, lbf | 633 | |
| Water Absorption, % wt | 6.5 | |

Example 2 depicts an exemplary PC manufactured with 26.9% post-consumer carpet waste. Similar to Example 1, the total weight of HDPE pellet and wood filler remains consistent with that utilized in Comparative Example 1, while the increased use of recycled carpet waste again decreases the percentage of those components within Example 2. The use of recycled carpet waste results in Example 2 failing at 605 lbf, with a displacement at failure of 1.662 inches. Again, the decrease in displacement at failure, as compared to both Comparative Example 1 and Example 1, is the subject of further study, but the decrease appears to be directly linked to the amount of recycled carpet waste present in Example 2. Presumably, a sample containing an even higher percentage of recycled carpet waste would have an even lower displacement at failure. Notably, again, the water absorption of Example 2 is lower than that of both Comparative Example 1 and Example 1. This is consistent with the observation that the increased amount of recycled carpet waste effectively decreases the percentage of wood filler within Example 2.

TABLE 12
Example 2

| | |
|---|---|
| FC | FC |

6524E

| Material | lb. | % |
|---|---|---|
| Main Feed | | |
| HDPE Pellet | 246.0 | 30.1 |
| Regrind (Pulverized) | 0.0 | 0.0 |
| Regrind (Flake) | 0.0 | 0.0 |
| Repro | 0.0 | 0.0 |
| Struktol 104 | 0.0 | 0.0 |
| Color | 12.0 | 1.5 |
| CW-1P | 0.0 | 0.0 |
| CW 2P | 220.0 | 26.9 |
| Side Feed | | |
| Wood Filler | 300.7 | 36.8 |
| Color | 0.0 | 0.0 |
| CW-1P | | 0.0 |
| CW-2P | | 0.0 |
| Struktol 104 | 38.0 | 4.7 |
| Formulation Weight | 816.7 | 100.0 |
| Rate, lb./hr. | 700 | |
| Stress, psi | 2926 | |
| Displ., in. | 1.662 | |
| MOE, psi | 568698 | |
| Load, lbf | 605 | |
| Water Absorption, % wt | 5.6 | |

Another embodiment of the invention includes the addition of chemical foaming agents (CFAs) to the extrusion process, wherein the extruded composite containing the carpet waste is foamed, thus allowing for reduced weight of the final product. The composite in this aspect of the invention contains polyethylene (HDPE, MDPE, LDPE, and LLDPE), polypropylene, PVC, and/or combinations thereof as the base polymer. The processed carpet waste added during the extrusion process may include wool, nylon, polyester, polypropylene, jute, sisal, and/or combinations thereof. Moreover, the additives identified above with regard to the non-foamed extrusions may also be utilized. The blends of carpet waste, polymer, fillers, and additives include composites with about 1% to about 96%, by weight, about 1% to about 60%, by weight, of processed carpet waste, about 10% to about 40%, by weight, of processed carpet waste, and about 15% to about 25%, by weight, of processed carpet waste. Additionally, the foamed composites have ratios of base polymer to filler material similar to those presented above with regard to the non-foamed composites.

In general, extruded plastic composite products have a specific gravity ranging from about 0.9 to about 1.5. By comparison, water has a specific gravity of 1.0. The specific gravity reflects the density of polymers and the fibers used in the extruded composite. Adding CFAs to the extrudable mixture decreases the density of the finished composite, which may provide certain performance and economic advantages.

A CFA may be added to the extrusion process, or the pressing and heating processes described above, to create a foam structure to the plastic composite, thereby reducing the specific gravity of the materials. This, in turn, offers a reduced weight and lower material content finished part. The choice of CFAs is dependent on the type of base polymer that is used in the composite formulation. Regardless of the base polymer, either endothermic or exothermic CFAs or blends of the two types, can be used to create a foam structure during the extrusion process. Extruded products made with CFAs may be produced with the extruder depicted above in FIG. 9. Tables 13 and 14 identify typical zone temperatures and other details regarding the extruder processing system employed in various embodiments of the invention. Temperatures for each zone, in a high/low range, are presented. Examples of PCs containing carpet wastes and CFAs manufactured in accordance with the ranges exhibited in these tables are described below. Temperature and other ranges outside of those depicted are also contemplated.

TABLE 13
Processing Parameters for Foamed Composites Including HDPE and Carpet Waste (Laboratory Equipment)

| | Melt Pump Inlet | | Melt Pump Outlet | | Extruder | Melt | Polymer | Wood | Added |
|---|---|---|---|---|---|---|---|---|---|
| | Matl. Temp. | Pressure | Matl. Temp. | Pressure | Speed | Pump | Feed | Feed | Wax |
| | deg C. | Bar | deg C. | Bar | rpm | rpm | lb./hr. | lb./hr | lb./hr. |
| High | 200 | 30 | N/A | 15 | 350 | 25 | 500 | 550 | 10 |
| Low | 150 | 25 | N/A | 10 | 250 | 15 | 350 | 450 | 0 |

| | Zone 0 | Zone 1 | Zone 2 | Zone 3 | Zone 4 | Zone 5 | Zone 6 | Zone 7 | Zone 8 | Zone 9 | Zone 10 | Zone 11 | Zone 12 |
|---|---|---|---|---|---|---|---|---|---|---|---|---|---|
| | Set | Set | Set | Set | Set | Set | Set | Set | Set | Set | Set | Set | Set |
| | deg C. | deg C. | deg C. | deg C. | deg C. | deg C. | deg C. | deg C. | deg C. | deg C. | deg C. | deg C. | deg C. |
| High | N/A | 210 | 230 | 230 | 230 | 220 | 190 | 180 | 180 | 170 | 170 | 160 | 160 |
| Low | N/A | 190 | 210 | 210 | 210 | 190 | 170 | 160 | 160 | 150 | 150 | 140 | 140 |

| | Adapter | Melt Pump | Y-block 1 | Y-block 2 | Y-block 3 | Die L1 | Die L2 | Die L3 | Die R1 | Die R2 | Die R3 |
|---|---|---|---|---|---|---|---|---|---|---|---|
| | Set | Set | Set | Set | Set | Set | Set | Set | Set | Set | Set |
| | deg C. | deg C. | deg C. | deg C. | deg C. | deg C. | deg C. | deg C. | deg C. | deg C. | deg C. |
| High | 160 | 160 | N/A | N/A | N/A | 160 | 160 | N/A | N/A | N/A | N/A |
| Low | 140 | 140 | N/A | N/A | N/A | 140 | 140 | N/A | N/A | N/A | N/A |

Specifically, Table 13 identifies process parameters for foamed extrusions including high-density polyethylene, natural fibers, and carpet waste, where the extrusions were made using laboratory equipment. Process parameters that are identified as “N/A” were not determinable, as the available laboratory equipment was not fitted with a Y-block adapter, and utilized only a single two-zone die (as opposed to the Y-block adapter and pairs of three-zone dies depicted in FIG. 12 and Table 8). Table 14 identifies process parameters for foamed extrusions, again, including high-density polyethylene, natural fibers, and carpet waste, as expected for manufacturing on production scale equipment similar to that depicted in FIG. 9.

TABLE 14
Processing Parameters for Foamed Composites Including HDPE and Carpet Waste (Production-Scale Equipment)

| | Melt Pump Inlet | | Melt Pump Outlet | | Extruder | Melt | Polymer | Wood | Added |
|---|---|---|---|---|---|---|---|---|---|
| | Matl. Temp. | Pressure | Matl. Temp. | Pressure | Speed | Pump | Feed | Feed | Wax |
| | deg C. | Bar | deg C. | Bar | rpm | rpm | lb./hr. | lb./hr | lb./hr. |
| High | 200 | 30 | 240 | 15 | 350 | 25 | 500 | 550 | 10 |
| Low | 150 | 25 | 150 | 10 | 250 | 15 | 350 | 450 | 0 |

| | Zone 0 | Zone 1 | Zone 2 | Zone 3 | Zone 4 | Zone 5 | Zone 6 | Zone 7 | Zone 8 | Zone 9 | Zone 10 | Zone 11 | Zone 12 |
|---|---|---|---|---|---|---|---|---|---|---|---|---|---|
| | Set | Set | Set | Set | Set | Set | Set | Set | Set | Set | Set | Set | Set |
| | deg C. | deg C. | deg C. | deg C. | deg C. | deg C. | deg C. | deg C. | deg C. | deg C. | deg C. | deg C. | deg C. |
| High | 60 | 230 | 230 | 230 | 230 | 210 | 190 | 185 | 170 | 150 | 140 | 135 | 130 |
| Low | 40 | 190 | 210 | 210 | 210 | 170 | 160 | 150 | 140 | 130 | 120 | 115 | 110 |

| | Adapter | Melt Pump | Y-block 1 | Y-block 2 | Y-block 3 | Die L1 | Die L2 | Die L3 | Die R1 | Die R2 | Die R3 |
|---|---|---|---|---|---|---|---|---|---|---|---|
| | Set | Set | Set | Set | Set | Set | Set | Set | Set | Set | Set |
| | deg C. | deg C. | deg C. | deg C. | deg C. | deg C. | deg C. | deg C. | deg C. | deg C. | deg C. |
| High | 160 | 160 | 170 | 170 | 170 | 170 | 170 | 170 | 170 | 170 | 170 |
| Low | 140 | 140 | 130 | 130 | 130 | 130 | 130 | 130 | 130 | 130 | 130 |

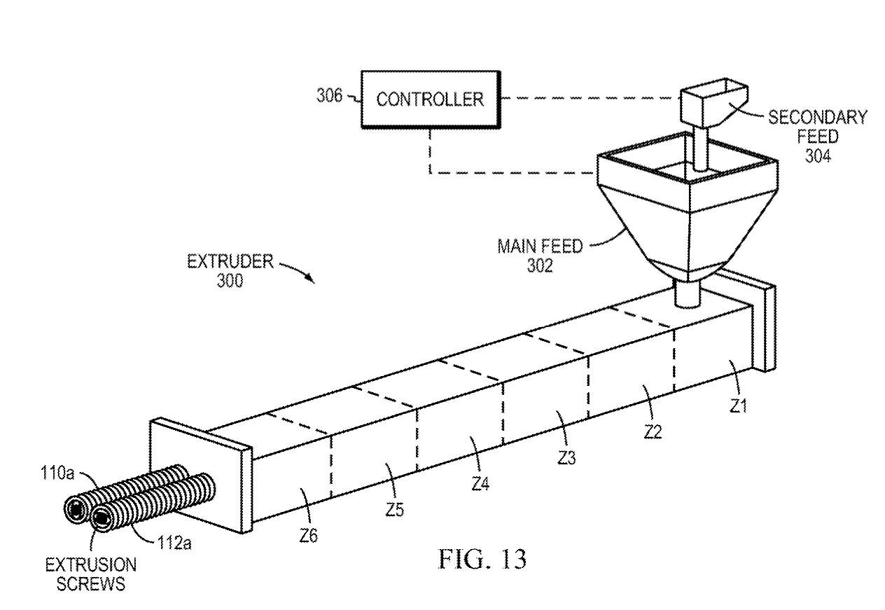

Referring to FIG. 13 and Table 15, a schematic perspective view of a PVC extruder 300 utilized in certain embodiments of the present invention is depicted. The PVC extruder includes a main feed 302, through which various components of the extrudable mixture may be introduced (e.g., the PVC compound, regrind, exothermic CFAs, and carpet waste). Additionally, endothermic CFAs and additional wood filler or other natural fibers may be introduced through a secondary feed 304, into the main feed 302. A controller 306 controls the introduction of all materials into the extruder 300, which consists of six zones Z1-Z6. Table 15 identifies process parameters for foamed extrusions including PVC carpet waste run on laboratory or process equipment (the same extrusion equipment may be used in both processes). Moreover, the equipment for PVC extrusions includes the Y-adapter and pair of three-zone dies, as depicted in FIG. 12. Information regarding the “Coextruder” portion of the table is described below.

TABLE 15
Processing Parameters for Foamed Composites Including PVC and Carpet Waste
Main Extruder

| | Zone 1 | Zone 2 | Zone 3 | Zone 4 | Zone 5 | Zone 6 | Adapter | Melt | Melt | Motor |
|---|---|---|---|---|---|---|---|---|---|---|
| | Set | Set | Set | Set | Set | Set | Set | Temp | Pressure | Current |
| | deg F. | deg F. | deg F. | deg F. | deg F. | deg F. | deg F. | deg F. | psi | % |
| High | 420 | 410 | 400 | 360 | 340 | 325 | 325 | 350 | 2600 | 65 |
| Low | 365 | 365 | 365 | 325 | 315 | 305 | 305 | 300 | 1500 | 35 |

Main Extruder

| | Y-block 1 | Y-block 2 | Y-block 3 | Die Left 1 | Die Left 2 | Die Left 3 | Die Rt. 1 | Die Rt. 2 | Die Rt. 3 |
|---|---|---|---|---|---|---|---|---|---|
| | Set | Set | Set | Set | Set | Set | Set | Set | Set |
| | deg F. | deg F. | deg F. | deg F. | deg F. | deg F. | deg F. | deg F. | deg F. |
| High | 360 | 360 | 360 | 360 | 360 | 360 | 360 | 360 | 360 |
| Low | 325 | 325 | 325 | 325 | 325 | 325 | 325 | 325 | 325 |

Coextruder

| | Zone 1 | Zone 2 | Zone 3 | Zone 4 | Motor |
|---|---|---|---|---|---|
| | Set | Set | Set | Load | Set |
| | deg C. | deg C. | deg C. | % | deg C. |
| High | 175 | 180 | 180 | 180 | 55 |
| Low | 145 | 150 | 155 | 160 | 40 |

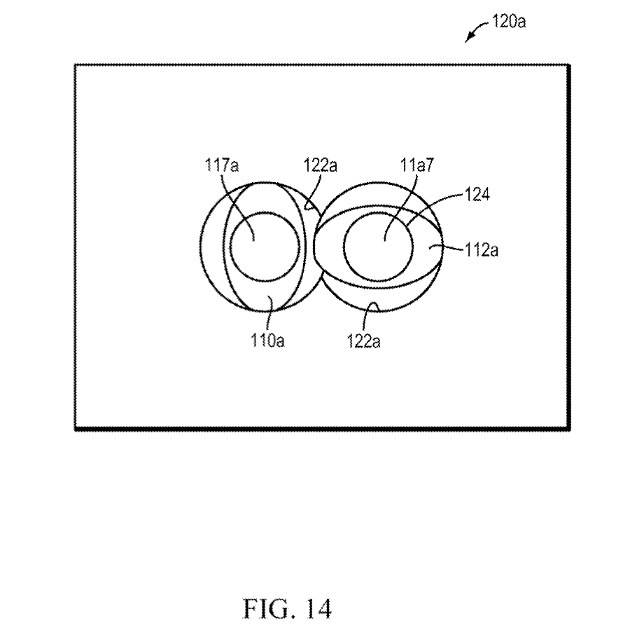

Extrusion screws 110a, 112a for the PVC extruder are depicted in FIG. 14 and may differ from those depicted in FIGS. 9-11. FIG. 14 is an end view of the extrusion barrel 120a, including the screws 110a, 112a. The screws 110a, 112a for the PVC extruder 300 are single screws that extend the length of the extruder 300, within a barrel 122a. They each consist of a single central shaft 117a, and are generally not comprised of multiple, individual segments; therefore, they lack the teeth present on the screws depicted in FIG. 11. The number of flights/in. may vary for each zone, as required for a particular application, to properly knead and push the extrusion material through the extruder.

Independent of the type of base polymer used in the composite formulation, the CFAs are added to the extrusion process at a level of about 0.1% to about 5.0% by weight of the total formulation. The foamed composite product may be produced on either a single-screw or twin-screw extruder. The CFA can be introduced to the extrusion process with any of the other compound ingredients, or it may be added directly into the extruder at a point further down the extruder and closer to the die. The CFA emits gases as its temperature rises inside the extruder and die. The gases are trapped inside the composite melt causing the formation of a cell structure within the composite. The type and amount of CFA determines the size of the individual cells, thus giving a fine or coarse cell structure. Additionally, the choice of CFA will determine whether the structure is open cell or closed cell. Closed cell composite building products may be used effectively outdoors, as the closed cell structure prevents the migration of water and contaminants through the interior of the extruded composite.

Table 16 and 17 illustrate the range of individual components that may be used to produce acceptable foamed PCs. Specifically, Table 16 depicts ranges for extruded materials consisting generally of high density polyethylene and/or polypropylene, CFAs, and carpet waste. It is shown that the recycled carpet waste can be added from about 1% to about 60% of the total formula weight and still retain acceptable physical properties in the extruded foamed component. Certain embodiments may include carpet wastes in the amount of about 10% to about 40% total weight. Still other embodiments may include carpet wastes in the amount of about 15% to about 25% total weight. Alternative embodiments may utilize between about 1% to about 96% carpet waste and still display desirable properties. Further, as discussed above, the recycled carpet waste can be added to the composite formulation at various ports on the extruder. As with non-foamed extrusion, there is no discernible difference in the extruded product when adding the recycled carpet waste resulting from the use of selvedge (CW-1), or mixed post-consumer carpet waste (CW-2) and unseparated processed carpet waste may be used in place of up to about 100% of the base polymer.

The formulation may also include an amount of natural filler from about 0% to about 80%, or preferably, from about 18% to about 55%. Further, different types of lubricant perform equally well in the processing. For example, where both a “one-pack” or combined specialty lubricant is used as well as an individual lubricant package (e.g., zinc stearate, EBS wax, etc.), the invention processed acceptably regardless of the lubricant approach to formulating. There are a number of acceptable CFAs that are contemplated. The preferred product acts as both an exothermic and an endothermic CFA, and produces satisfactory results with PCs utilizing HDPE or polypropylene and carpet waste. Within the ranges of components depicted in Table 16, certain formulations have proven particularly desirable for commercial purposes. One such embodiment of the composite material is comprised of the following: about 24.4% HDPE, about 8.1% pulverized regrind, about 19.8% unseparated processed carpet waste, about 39.8% natural fibers, about 1.2% foaming agent, about 4.6% lubricant, and about 2.0% color.

TABLE 16
Formulations for Extruded Composites Utilizing HDPE and CFA

Range

| Material | Low % | High % |
|---|---|---|
| Main Feed | | |
| HDPE pellet/powder | 20 | 45 |
| Regrind (pulverized) | 0 | 12 |
| Regrind (flake) | 0 | 12 |
| Repro | 0 | 6 |
| Lubricant* | 4 | 7 |
| Color | 1 | 2 |
| CW-1 | 1 | 60 |
| CW-2 | 1 | 60 |
| CW-1/CW-2** | 1 | 96 |
| Chemical Foaming Agent | 0.1 | 5 |
| Side Feed | | |
| Wood filler | 0 | 80 |
| Color | 1 | 2 |
| CW-1 | 1 | 60 |
| CW-2 | 1 | 60 |
| Lubricant* | 4 | 7 |
| Chemical Foaming Agent | 0.1 | 5 |

*Lubricants: separate addition of zinc stearate and EBS wax or addition of specialty lubricant Struktol 104.
**Elevated percentages of carpet waste are utilized when virgin base polymer approaches 0% of the total composite formulation

Table 17 depicts ranges for extruded materials consisting generally of PVC compound, CFAs, and carpet waste. Recycled carpet waste may be added to the formulation from about 1% to about 96%, by weight, of the total formula, and more preferably from about 1% to about 30%, by weight. Wood filler may also be added from about 0% to about 80%, and more preferably from about 0% to about 20%. The PVC compound (exemplary formulations being the 3040ANT-3000 and 3314BNT-1000 compounds manufactured by Aurora Plastics) includes an exothermic CFA in the formulation, although exothermic CFAs may also be added separately to the main feed. An exemplary exothermic CFA is the 19903T1 product manufactured by Americhem, Inc. Endothermic CFAs may also be added to the extrudable mixture. The effect of exothermic CFAs on extruded materials may vary, depending on moisture in the process environment, moisture in the process materials, extruder temperatures, and other factors. Endothermic CFAs control the foaming process to produce a satisfactory extruded foamed product. In general, the amount of exothermic CFA to endothermic CFA may be in a ratio of about 1.0:0.75, but that ratio may vary. Methods of varying the ratio of exothermic CFAs to endothermic CFAs to produce foamed PCs are known to those of ordinary skill in the art. An exemplary endothermic CFA is the 20429T1 product manufactured by Americhem, Inc. Within the ranges of components depicted in Table 17, certain formulations have proven particularly desirable for commercial purposes. One such embodiment of the composite material is comprised of the following: about 68.5% PVC, about 20.3% PVC regrind, about 10.0% unseparated processed carpet waste, and about 1.2% foaming agent.

TABLE 17
Formulations for Extruded Composites Utilizing PVC and CFA

Range

| Material | Low % | High % |
|---|---|---|
| Main Feed | | |
| PVC Compound | 50 | 99 |
| (Aurora foam cmpd.) | | |
| Regrind | 0 | 50 |
| Exothermic CFA | 0.5 | 37 |
| (incl. in PVC compound) | | |
| CW-1 | 1 | 96 |
| CW-2 | 1 | 96 |
| Secondary Feed | | |
| Endothermic CFA | 0.1 | 2 |
| Wood filler | 0 | 80 |

At least two types of foaming processes may be utilized for PCs utilizing carpet waste, with satisfactory results. These processes are referred to freefoam and Celuka processes. In general, mixtures utilizing polyolefins may be manufactured using the freefoam process, in which the die size is smaller than the desired final size of the extruded product. In the freefoam process, the foaming expands the outer dimensions of the product. As an example, a sample with an extruded thickness of 1 in. would pass though a die of approximately 0.7 in., before expanding to its final size. Die sizing considerations for freefoam processes are known to those of ordinary skill in the art.

Mixtures utilizing PVC mixtures may be manufactured utilizing the Celuka process. In the Celuka process, the mixture is extruded around a mandrel or other component that forms a void or hollow within the middle of the extruded product. Once the extruded product passes beyond the mandrel, and as the product cools, it expands into the void, while maintaining a substantially consistent outer profile. The extruded product may expand to completely fill the void or may leave a hollow core, which reduces total weight of the finished product. In one example, if it is desired to reduce the weight of a finished product of uniform thickness by approximately 50%, the mandrel would be approximately 45% of the area of the profile, depending on the amount, type, etc., of foaming agent. Die and mandrel sizing considerations for the Celuka process are known to those of ordinary skill in the art.

In addition to the two processes noted above, calibration may be utilized downstream of the extruder to control the foamed expansion process. In certain embodiments, the extruded mixture is passed through one or more secondary dies or calibrators to control the foaming expansion process so the extruded material can obtain a final, exact dimension. The calibrator(s) utilize both vacuum pressure, to control a pressure differential of the environment to prevent shrinkage of the extruded mixture, and water, to cool and lubricate the mixture, thus controlling the temperature. The number of calibrators used may be varied depending on application and tolerances required in the finished product. Certain embodiments may use up to five or more calibrators. In addition to die utilizing vacuum and water cooling, templates that utilize only vacuum to control shrinkage may be utilized for calibration, again, depending on application, desired finished profile, etc.

The addition of the CFA creates a significant change in the specific gravity of the material in the finished part. In one embodiment using a polyolefin base polymer with natural fiber and processed carpet waste as the composite material, a specific gravity of approximately 0.75 can be achieved, if a foaming agent is used. Without the foaming agent, a composite material made with the same components has a specific gravity of approximately 1.10. Similarly, a composite consisting of a PVC base polymer and processed carpet waste can be reduced in specific gravity from approximately 1.4 for the solid composite to approximately 0.6 for the foamed composite.

Tables 18, 19, and 20 depict various examples of extruded foam products utilizing HDPE. In all of these examples, no water absorption tests were performed, but it is expected that under the FCQA Water Absorption Test, absorption amounts of not more than about 15% by weight are obtained after exposure to 30 days of water submersion; amounts of not more than about 17% by weight may also be obtained after exposure to 30 days of boiling water submersion.

Comparative Example 2 is a PC manufactured in accordance with known processes, and having an HDPE base mixture, but without the use of recycled carpet waste or CFAs. As can be seen, Comparative Example 2 fails at 645 lbf, with a displacement at failure of 2.303 inches.

TABLE 18
Comparative Example 2

| | |
|---|---|
| FC | FC |

6214A

| Material | lb. | % |
|---|---|---|
| Main Feed | | |
| HDPE pellet/powder | 184.5 | 31.8 |
| Regrind (pulverized) | 61.5 | 10.6 |
| Regrind (flake) | | 0.0 |
| Repro | | 0.0 |
| Lubricant | 33.0 | 5.7 |
| Color | | 0.0 |
| CW 1 | | 0.0 |
| CW 2 | | 0.0 |
| Chemical Foaming Agent | | 0.0 |
| Side Feed | | |
| Wood filler | 300.7 | 51.9 |
| Color | | 0.0 |
| CW 1 | | 0.0 |
| CW 2 | | 0.0 |
| Lubricant | | 0.0 |
| Chemical Foaming Agent | | 0.0 |
| Formulation Weight | 579.7 | 100.0 |
| Rate, lb./hr. | 1000 | good |
| | | sg = 1.11 |
| Stress, psi | | 3146 |
| Displacement, in. | | 2.303 |
| MOE, psi | | 651886 |
| Load, lbf. | | 645 |
| Water Absorption, % wt | | |

Comparative Example 3 depicts a PC manufactured utilizing HDPE and 2% CFA. As can be seen, the specific gravity of the PC utilizing CFA is reduced from that of the PC without the CFA. The use of CFA affects the performance of the product, as indicated by failure at 722 lbf., at a displacement of 1.604 inches.

TABLE 19
Comparative Example 3

| | |
|---|---|
| FC | FC |

6214D

| Material | lb. | % |
|---|---|---|
| Main Feed | | |
| HDPE pellet/powder | 184.5 | 30.6 |
| Regrind (pulverized) | 61.5 | 10.2 |
| Regrind (flake) | | 0.0 |
| Repro | | 0.0 |
| Lubricant | 33.0 | 5.5 |
| Color | | 0.0 |
| CW 1 | | 0.0 |
| CW 2 | | 0.0 |
| Chemical Foaming Agent | 12.0 | 2.0 |
| Side Feed | | |
| Wood filler | 300.7 | 49.8 |
| Color | | 0.0 |
| CW 1 | | 0.0 |
| CW 2 | | 0.0 |
| Lubricant | | 0.0 |
| Chemical Foaming Agent | 12 | 2.0 |
| Formulation Weight | 603.7 | 98.0 |
| Rate, lb./hr. | 1000 | good |
| | | sg = .85 |
| Stress, psi | | 2390 |
| Displacement, in. | | 1.604 |
| MOE, psi | | 469645 |
| Load, lbf. | | 722 |
| Water Absorption, % wt | | |

Example 3 depicts the quantities of compounds required for an exemplary PC manufactured in accordance with the present invention, with HDPE, 19.8% post-consumer carpet waste, and 1.6% CFA. The anticipated performance characteristics of a product manufactured with this formulation are also depicted. This extruded material should fail at approximately 700 lbf, and at a displacement of about 1.6 inches. Additionally, the specific gravity of the sample is expected to be similar to that of Comparative Example 3.

TABLE 20
Example 3

| | FC | FC |
|---|---|---|
| Material | lb. | % |
| Main Feed | | |
| HDPE pellet/powder | 184.5 | 24.3 |
| Regrind (pulverized) | 61.5 | 8.1 |
| Regrind (flake) | | 0.0 |
| Repro | | 0.0 |
| Lubricant | 38.0 | 5.0 |
| Color | | 0.0 |
| CW 1 | 150.0 | 19.8 |
| CW 2 | | 0.0 |
| Chemical Foaming Agent | 12.0 | 1.6 |
| Side Feed | | |
| Wood filler | 300.7 | 39.6 |
| Color | | 0.0 |
| CW 1 | | 0.0 |
| CW 2 | | 0.0 |
| Lubricant | | 0.0 |
| Chemical Foaming Agent | 12 | 1.6 |
| Formulation Weight | 758.7 | 98.4 |
| Rate, lb./hr. | | |
| | | sg = .80 |
| Stress, psi | | 2400 |
| Displacement, in. | | 1.6 |
| MOE, psi | | 470000 |
| Load, lbf. | | 700 |
| Water Absorption, % | | |

Table 21, 22, and 23 depicts various examples of extruded foam products utilizing PVC. In all of these examples, no water absorption tests were performed.

Comparative Example 4 is a PC manufactured utilizing a PVC compound, but without the use of recycled carpet waste or CFAs. As can be seen, the density of the finished extruded material is 1.3 g/cc.

TABLE 21
Comparative Example 4

| | FC | FC |
|---|---|---|
| Material | lb. | % |
| Main Feed | | |
| PVC Compound (AP2221E) | 390.0 | 48.1 |
| Lubricant SA 0012 | 6.0 | 0.7 |
| Talc | 24.0 | 3.0 |
| Regrind | 195.0 | 24.1 |
| CW-1P | 0.0 | 0.0 |
| Pine Wood Filler | 195.0 | 24.1 |
| Secondary Feed into Main Feed | | |
| N/A | | |
| Formulation Weight | 810.0 | 100.0 |
| Rate, lb./hr. | | |
| Stress, psi | 2200 | |
| Displacement, in. | | |
| MOE, psi | 820000 | |
| Load, lbf. | 270 | |
| Density, g/cc | 1.30 | |

Comparative Example 5 depicts a PC manufactured utilizing PVC compound and endothermic and exothermic CFAs of 0.8% and 0.5%, respectively. As can be seen, the specific gravity of the PC utilizing CFAs is reduced from that of the PC without CFAs by about 50%.

TABLE 22
Comparative Example 5

| | |
|---|---|
| FC | FC |

720B

| Material | lb. | % |
|---|---|---|
| Main Feed | | |
| PVC Compound | 152.4 | 98.7 |
| incl. Exothermic CFA 19903-T1 | 1.2 | 0.8 |
| CW-1P | | 0.0 |
| | | 0.0 |
| Secondary Feed into Main Feed | | |
| Endothermic CFA 20429-T1 | 0.8 | 0.5 |
| added separately | | |
| Formulation Weight | 154.4 | 100.0 |
| Rate, lb./hr. | | |
| Stress, psi | 4460 | |
| Displacement, in. | | |
| MOE, psi | 175648 | |
| Load, lbf. | 252 | |
| Density, g/cc | 0.68 | |

Example 4 depicts an exemplary PC manufactured with a PVC compound, 8.9% post-consumer carpet waste, and exothermic and endothermic CFAs at 0.7% and 0.5%, respectively. As noted, the specific gravity of this extruded product does not differ from Comparative Example 5, and its load at failure is comparable.

TABLE 23
Example 4

| | |
|---|---|
| FC | FC |

720D

| Material | lb. | % |
|---|---|---|
| Main Feed | | |
| PVC Compound | 152.4 | 90.0 |
| incl. Exothermic CFA 19903-T1 | 1.2 | 0.7 |
| CW-1P | 15.0 | 8.9 |
| Secondary Feed into Main Feed | | |
| Endothermic CFA 20429-T1 | 0.8 | 0.5 |
| added separately | | |
| Formulation Weight | 169.4 | 100.0 |
| Rate, lb./hr. | | |
| Stress, psi | 3980 | |
| Displacement, in. | | |
| MOE, psi | 177510 | |
| Load, lbf. | 242 | |
| Density, g/cc | 0.68 | |

Example 5 depicts an exemplary PC in which no virgin base polymer is utilized. Instead, the composite includes 60.9% unseparated processed carpet waste, 30% wood filler, and Zinc Borate, lubricant and color in minimal amounts. The resulting composite has a high MOE, at least in part due to the proportion of wood filler to carpet waste, and a thorough distribution of wood filler and carpet waste within the composite.

TABLE 24
Example 5

| | |
|---|---|
| FC | FC |

71018D

| Material | lb. | % |
|---|---|---|
| Main Feed | | |
| HDPE Pellet | 0.0 | 0.0 |
| Regrind (Pulverized) | 0.0 | 0.0 |
| Regrind (Flake) | 0.0 | 0.0 |
| Repro | 0.0 | 0.0 |
| Struktol 104 | 18.4 | 4.6 |
| CW | 246.0 | 60.9 |
| Zn Borate | 0.0 | 0.0 |
| HD Color | 12.0 | 3.0 |
| Side Feed | | |
| Wood filler | 121.0 | 30.0 |
| Alterform 1050 | 0.0 | 0.0 |
| Compatibilizer | 0.0 | 0.0 |
| Zinc Borate | 6.4 | 1.6 |
| | | 0.0 |
| Total | 403.8 | 100.0 |
| Rate, lb./hr. | 800 | |
| Stress, psi | 2784 | |
| Displ., in. | 0.834 | |
| MOE, psi | 693221 | |
| Load, lbf | 612 | |

Example 6 depicts an exemplary PC manufactured in which no virgin base polymer or wood is utilized. Instead, the composite includes 88.5% unseparated processed carpet waste, with Zinc Borate, lubricant and color in minimal amounts.

TABLE 25
Example 6

| | |
|---|---|
| FC | FC |

71018A

| Material | lb. | % |
|---|---|---|
| Main Feed | | |
| HDPE Pellet | 0.0 | 0.0 |
| Regrind (Pulverized) | 0.0 | 0.0 |
| Regrind (Flake) | 0.0 | 0.0 |
| Repro | 0.0 | 0.0 |
| Struktol 104 | 14.8 | 5.5 |
| CW | 239.0 | 88.5 |
| Zn Borate | 0.0 | 0.0 |
| HD Color | 12.0 | 4.4 |
| Side Feed | | |
| Wood filler | 0.0 | 0.0 |
| Alterform 1050 | 0.0 | 0.0 |
| Compatibilizer | 0.0 | 0.0 |
| Zinc Borate | 4.4 | 1.6 |
| | | 0.0 |
| Total | 270.2 | 100.0 |
| Rate, lb./hr. | 650 | |
| Stress, psi | | 2227 |
| Displ., in. | | 1.214 |
| MOE, psi | | 335160 |
| Load, lbf | | 452 |

Another aspect of the extrusion of composites containing processed carpet waste is the addition of a “capstock” during the extrusion process. A capstock is a polymeric coating that is applied to one or more sides of the extruded profile, so as to provide improved or altered physical properties on the surface of the extruded part. The capstock is a thermoplastic material compatible with the polymers in the core extrusion, allowing a bonding of the core and the capstock. The coating is coextruded with the main extrusion as part of the forming of the finished extruded profile. The purpose of this extrusion technique is to give the surface of the extruded product particular physical properties (e.g., abrasion resistance or slip resistance), and/or alternative decorating possibilities. The thickness of a capstock may be about 0.002 inches to about 0.04 inches. Capstock thickness of about 0.01 inches are typical for certain embodiments. Table 15 depicts settings for a coextruder used to produce capstock on a PVC core material.

The method of coating an extruded product with a thermoplastic material during the extrusion process is referred to as “capping” or “capstocking” This specific process is accomplished by co-extruding the capstock onto the core material in the forming die. As the composite material is passing through the die, a second extruder pushes a thermoplastic material into the die and subsequently, this capstock material flows around the core to give a coating to the extruded composite product. Methods of applying capstock via coextrusion processes are known by those of ordinary skill in the art.

One purpose of the capstock process is to change the surface of the extruded composite product so that properties such as weatherability, fade resistance, stain resistance, slip resistance and wear resistance can be improved or modified. Composites containing processed carpet waste may also be capstocked, and the process may be applied to both solid and foamed extruded composites. The solid extruded composite products contain 1% to 96% by weight of the processed carpet waste. Extruded composite products that are foamed may also contain about 1% to about 96% by weight of the processed carpet waste. Other embodiments may include about 1% to about 25% by weight processed carpet waste.

The capstock is a thermoplastic material that is compatible with the polymers contained in the solid or foamed composite extrusion. Specific examples for use with PVC-core composites include ASA and PVC compounds. Other thermoplastic or polymer materials that are capable of flowing through the capstock die to produce a capstock of the desired thickness may also be used. Whether the core composite is solid or foamed, the capstock is a solid thermoplastic coating. In one embodiment, the capstock includes an ionomer. See, for example, U.S. patent application Ser. No. 12/643,442, published as U.S. Patent Application Publication No. 2010/0159213, for additional capstock formulations, the disclosure of which is hereby incorporated by reference herein in its entirety.

In any embodiment of the invention utilizing recycled carpet waste, the outer surface of the plastic composite may be treated with foil or film laminates. Processes and materials related thereto are disclosed in U.S. patent application Ser. No. 11/054,258, filed Feb. 9, 2005, and entitled “Foil or Film Laminated Enhanced Natural Fiber/Polymer Composite”; and in U.S. Provisional Patent Application Ser. No. 60/641,308, filed Jan. 4, 2005, and entitled “Foil or Film Laminated Enhanced Wood/Polymer Composite” the disclosures of which are hereby incorporated by reference herein in their entireties.

In another embodiment, like the plastic composites formed by compression, described above, it has been discovered that fly ash may be incorporated into the plastic composites formed by extrusion. The fly ash may be used to replace, in whole or in part, the natural fibers (wood flour and the like), with very little deviation from the processing parameters described above for composites containing carpet waste and wood. Use of fly ash in extruded plastic composites has economic, environmental, and performance advantages. With regard to economics, fly ash is generally less expensive than natural fibers such as wood and wood flour. Environmentally, fly ash must be disposed of or otherwise contained to prevent dispersal, inhalation, or other contamination. Fly ash consists almost exclusively of metal oxides, and absorbs considerably less moisture than other natural fibers, such as wood. Therefore, when used in a plastic composite, degradation due to mold growth and water absorption are greatly reduced. If fly ash completely replaces the natural fibers in a wood-plastic composite, mold growth and water absorption may be substantially or completely eliminated. Additionally, fly ash imparts substantially the same or similar stiffening properties to plastic composites as natural fibers, such as wood.

Fly ash may be introduced to the twin screw extrusion system depicted in FIG. 10 at either of the two entry ports. It may be desirable to introduce the fly ash into the second entry port 132b, to limit the amount of time the abrasive fly ash remains in the extruder. It may be advantageous to introduce lubricants into the extruder to help prevent damage to the screws, but lubricant is not necessary. Care should be taken, however, to ensure that excessive wear to the screw does not cause damage to the extruder. Notably, with few modifications, the various types of extrusion equipment (i.e., commercial and laboratory extruders) described herein may be used to manufacture extruded composites utilizing fly ash.

Plastic composites incorporating fly ash may utilize base polymers, carpet waste, or combinations thereof. The base polymers and carpet waste may be the same as or similar to those described above. In a particular embodiment, unseparated processed carpet waste may be utilized. Table 26 depicts one embodiment of processing parameters for manufacturing extruded plastic composites, wherein carpet waste consisting almost exclusively of polyester carpet is used, along with fly ash and lubricants. Notably, the temperatures in Zones 1-4 are higher than the temperatures depicted in the same zones in Table 8. This is due to the inclusion of polyester-face fiber carpet waste, which requires higher initial processing temperatures. In certain embodiments, the temperatures used to process composites having natural fibers are about the same as the temperatures used to process composites having fly ash.

TABLE 26
Processing Parameters for Composites Including Polyester Carpet Waste and Fly Ash

| | Melt Pump Inlet | | Melt Pump Outlet | | Extruder | Melt | Polymer | Wood | Added |
|---|---|---|---|---|---|---|---|---|---|
| | Mat'l Temp | Pressure | Mat'l Temp | Pressure | Speed | Pump | Feed | Feed | Wax |
| | P.A.I. deg C. | Bar | P.A.I deg C. | Bar | rpm | rpm | lb/hr | lb/hr | lb/hr |
| High | 180 | 18 | 180 | 18 | 350 | 25 | 2200 | 1000 | 10 |
| Low | 150 | 7 | 150 | 7 | 250 | 5 | 960 | 900 | 0 |

| | Zone 0 | Zone 1 | Zone 2 | Zone 3 | Zone 4 | Zone 5 | Zone 6 | Zone 7 | Zone 8 | Zone 9 | Zone 10 | Zone 11 | Zone 12 |
|---|---|---|---|---|---|---|---|---|---|---|---|---|---|
| | Set | Set | Set | Set | Set | Set | Set | Set | Set | Set | Set | Set | Set |
| | deg C. | deg C. | deg C. | deg C. | deg C. | deg C. | deg C. | deg C. | deg C. | deg C. | deg C. | deg C. | deg C. |
| High | 60 | 290 | 290 | 290 | 290 | 200 | 180 | 165 | 155 | 140 | 135 | 125 | 120 |
| Low | 40 | 190 | 190 | 190 | 190 | 180 | 170 | 155 | 145 | 130 | 125 | 115 | 110 |

| | Adapter | Melt Pump | Y-block 1 | Y-block 2 | Y-block 3 | Die L1 | Die L2 | Die L3 | Die R1 | Die R2 | Die R3 |
|---|---|---|---|---|---|---|---|---|---|---|---|
| | Set | Set | Set | Set | Set | Set | Set | Set | Set | Set | Set |
| | deg C. | deg C. | deg C. | deg C. | deg C. | deg C. | deg C. | deg C. | deg C. | deg C. | deg C. |
| High | 155 | 155 | 155 | 155 | 155 | 155 | 155 | 155 | 155 | 155 | 155 |
| Low | 140 | 140 | 140 | 140 | 140 | 140 | 140 | 140 | 140 | 140 | 140 |

Table 27 depicts formulation ranges for plastic composites utilizing carpet waste and fly ash, as well as other components. As described above, the fly ash may completely or partly replace the wood or other natural fiber filler. In certain embodiments, due to the weight of the fly ash used in the formulations, density reduction methods are used to reduce the weight of the finished product, depending on the desired final application for the product. As described above, density reduction may include use of endothermic, exothermic, or endothermic/exothermic blend chemical foaming agents in the formulation, injection of gas such as nitrogen or carbon dioxide into the extruder, or other physical foaming agents.

TABLE 27
Formulation Ranges for Plastic Composites Utilizing Carpet Waste and
Fly Ash

Range

| Material | Low % | High % |
|---|---|---|
| Main Feed | | |
| HDPE pellet/powder | 0 | 50 |
| Regrind (pulverized) | 0 | 12 |
| Regrind (flake) | 0 | 12 |
| Repro | 0 | 6 |
| Lubricant* | 2 | 7 |
| Color | 1 | 3 |
| CW-1 | 1 | 80 |
| CW-2 | 1 | 80 |
| CW-1/CW-2** | 50 | 80 |
| Chemical Foaming Agent | 0.1 | 5 |
| Side Feed | | |
| Fly ash | 0 | 80 |
| Wood filler | 0 | 80 |
| Color | 1 | 3 |
| CW-1 | 1 | 80 |
| CW-2 | 1 | 80 |
| Lubricant* | 2 | 7 |
| Chemical Foaming Agent | 0.1 | 5 |

*Lubricants: separate additon of zinc stearate and EBS wax or addition of specialty lubricant Struktol 104.
**Elevated percentages of carpet waste are utilized when virgin base polymer approaches 0% of the total composite formulation

The percentages of components may be adjusted as required or desired to obtain final products having the desired performance characteristics. Extruded products utilizing fly ash up to about 80%, between about 10% to about 50%, or between about 35% to about 50%, by weight, produce extruded composites with desirable performance characteristics for deckboard and other outdoor building material applications. The fly ash percentages described above for composites formed by heating and pressing may also be used for extruded composites. The extruded composites containing fly ash may be finished as described herein. Finishing may include capstocking of the extruded deckboard with, for example, the processes and materials described above.

The following patent applications are hereby incorporated herein by reference in their entireties: U.S. patent application Ser. No. 11/846,865, filed Aug. 29, 2007, entitled “Carpet Waste Composite”; U.S. patent application Ser. No. 11/514,303, filed Aug. 31, 2006, entitled “Carpet Waste Composite”; U.S. patent application Ser. No. 11/507,366, filed Aug. 21, 2006, entitled “Carpet Waste Composite”; U.S. Provisional Patent Application Ser. No. 60/760,500, filed Jan. 20, 2006, entitled “Carpet Waste Composite”; U.S. patent application Ser. No. 12/023,575, filed Aug. 31, 2008, entitled “Plastic Composites Using Recycled Carpet Waste and Systems and Methods of Recycling Carpet Waste”; U.S. patent application Ser. No. 11/943,848, filed Nov. 21, 2007, entitled “Wood-Plastic Composites Using Recycled Carpet Waste and Systems and Methods of Manufacturing”; U.S. Provisional Patent Application Ser. No. 60/860,872, filed Nov. 22, 2006, entitled “Wood-Plastic Composites Using Recycled Carpet Waste and Systems and Methods of Manufacturing”; and U.S. Provisional Patent Application Ser. No. 60/919,335, filed Mar. 21, 2007, entitled “Foamed Wood-Plastic Composites Using Recycled Carpet Waste and Systems and Methods of Manufacturing.”

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations, materials, and dimensions described herein are intended as illustrative and in no way limiting. Similarly, although physical explanations have been provided for explanatory purposes, there is no intent to be bound by any particular theory or mechanism, or to limit the claims in accordance therewith.

What is claimed is:

1. A composite building material comprising a homogeneous mixture of:
carpet waste comprising carpet fibers and adhesive; and
an inorganic filler comprising fly ash.

2. The composite building material of claim 1, wherein the composite building material comprises between about 1% and about 98% carpet waste, by weight of the composite.

3. The composite building material of claim 2, wherein the composite building material comprises between about 10% and about 80% carpet waste, by weight of the composite.

4. The composite building material of claim 3, wherein the composite building material comprises between about 40% and about 80% carpet waste, by weight of the composite.

5. The composite building material of claim 1, wherein the composite building material comprises between about 1% and about 80% fly ash, by weight of the composite.

6. The composite building material of claim 5, wherein the composite building material comprises between about 15% and about 60% fly ash, by weight of the composite.

7. The composite building material of claim 6, wherein the composite building material comprises between about 20% and about 30% fly ash, by weight of the composite.

8. The composite building material of claim 5, wherein the composite building material comprises between about 10% and about 50% fly ash, by weight of the composite.

9. The composite building material of claim 6, wherein the composite building material comprises between about 35% and about 50% fly ash, by weight of the composite.

10. The composite building material of claim 1, wherein the inorganic filler further comprises calcium carbonate.

11. The composite building material of claim 1, wherein the composite building material further comprises calcium carbonate, beyond an amount present within the carpet waste.

12. The composite building material of claim 1, wherein the composite building material further comprises between about 1% and about 80% calcium carbonate, by weight of the composite.

13. The composite building material of claim 12, wherein the composite building material comprises between about 15% and about 60% calcium carbonate, by weight of the composite.

14. The composite building material of claim 13, wherein the composite building material comprises between about 20% and about 30% calcium carbonate, by weight of the composite.

15. The composite building material of claim 1, further comprising a hydrophobic agent.

16. The composite building material of claim 15, wherein the hydrophobic agent comprises slack wax.

17. The composite building material of claim 16, wherein the composite building material comprises between about 0.5% and about 10% slack wax, by weight of the composite.

18. The composite building material of claim 17, wherein the composite building material comprises between about 1% and about 3% slack wax, by weight of the composite.

19. The composite building material of claim 1, further comprising a binding agent in intimate association with the carpet waste and the fly ash.

20. The composite building material of claim 1, further comprising a lubricant.

21. The composite building material of claim 1, wherein the carpet waste comprises at least one of polypropylene, nylon 6, and nylon 6,6.

22. The composite building material of claim 1, wherein the carpet waste comprises face fibers comprising polyester.

23. The composite building material of claim 1, further comprising natural fibers.

24. The composite building material of claim 23, wherein the natural fibers are selected from the group consisting of wood chips, wood flour, wood flakes, wood shavings, sawdust, flax, jute, abaca, hemp, rice hulls, kenaf, and combinations thereof.

25. The composite building material of claim 1, further comprising a foaming agent.

26. The composite building material of claim 1, further comprising an additive selected from the group consisting of a colorant, a flame retardant, a compatiblizer, a coupling agent, a mold inhibitor, and combinations thereof.

27. The composite building material of claim 1, further comprising a base polymer.

28. The composite building material of claim 1, wherein the composite building material is characterized by an absence of natural fibers.

29. The composite building material of claim 1, wherein the carpet waste comprises at least one of a minimally processed carpet waste, an unseparated processed carpet waste, and a de-calcified carpet waste.

30. The composite building material of claim 1, wherein the carpet waste is selected from the group consisting of pelletized carpet waste, powdered carpet waste, and combinations thereof.

31. The composite building material of claim 1, wherein the composite building material is selected from the group consisting of siding, a shingle, a deck board, a trim board, a tile backerboard, floor underlayment, and a soffit.

32. A method of manufacturing a composite building material, the method comprising the steps of:
a) providing carpet waste comprising carpet fibers and adhesive;
b) mixing the carpet waste with an inorganic filler comprising fly ash to produce a homogeneous blend; and
c) forming the homogeneous blend into the composite building material.

33. The method of claim 32, wherein the carpet waste is selected from the group consisting of pelletized carpet waste, powdered carpet waste, and combinations thereof.

34. The method of claim 32, wherein the inorganic filler further comprises calcium carbonate.

35. The method of claim 32 wherein the mixing step further comprises adding a hydrophobic agent.

36. The method of claim 35, wherein the hydrophobic agent comprises slack wax.

37. The method of claim 32, wherein the mixing step further comprises adding a binding agent.

38. The method of claim 37, wherein the binding agent comprises one or more of methylenediphenyldiisocyanate (MDI), urea formaldehyde (UF), melamine urea formaldehyde (MUF), and phenol formaldehyde (PF).

39. The method of claim 37, wherein the composite building material comprises between about 10% and about 98% carpet waste and between about 2% and about 20% binding agent, by weight of the composite.

40. The method of claim 32, wherein the forming step occurs in at least one of a continuous press and a cycle press.

41. The method of claim 32, wherein the mixing step occurs in an extruder.

42. The method of claim 41, wherein the forming step comprises passing the homogeneous mixture through an extrusion die.

43. The method of claim 32, wherein the composite building material is selected from the group consisting of siding, a shingle, a deck board, a trim board, tile backerboard, floor underlayment, and a soffit.

44. A composite building material manufactured according to the process of claim 32.
